(19) United States
(12) Patent Application Publication
(10) Pub. No.: US 2015/0015917 A1
(43) Pub. Date: Jan. 15, 2015

(54) IMAGE PROCESSING APPARATUS, IMAGE FORMING APPARATUS, IMAGE PROCESSING METHOD, AND STORAGE MEDIUM

(71) Applicant: SHARP KABUSHIKI KAISHA, Osaka-shi, Osaka (JP)

(72) Inventors: Hitoshi Hirohata, Osaka-shi (JP); Yohsuke Konishi, Osaka-shi (JP); Makio Gotoh, Osaka-shi (JP); Masakazu Ohira, Osaka-shi (JP)

(21) Appl. No.: 14/375,302

(22) PCT Filed: Jan. 29, 2013
(86) PCT No.: PCT/JP2013/051924

§ 371 Date: Jul. 29, 2014

(30) Foreign Application Priority Data
Jan. 31, 2012 (JP) 2012-019147

(51) Int. Cl. G06K 15/02

(52) U.S. Cl. CPC G06K 15/1868
USPC 358/3.24

(57) ABSTRACT

An image processing apparatus (3) includes: a detection processing section which detects, for each page of an original document with a plurality of pages, the feature of image data of each page; a detection result calculation section (51) which (i) accumulates the feature detected and (ii) calculates a frequency of the feature of the original document; and a setting section (52) which sets a common feature, as the feature, to the image data of the plurality of pages of the original document in accordance with the frequency.

### TECHNICAL FIELD

The present invention relates to an image processing apparatus, an image forming apparatus, a method of processing an image, a program, and a storage medium, each of which carries out processing with respect to image data read by an image reading device such as a scanner.

### BACKGROUND ART

In recent years, (i) a digital technique has been widely spread and (ii) a processing capability of a computer with respect to image data has been improved. This causes an increase in mass storage of a storage device such as a hard disk. Accordingly, a conversion of a paper document into electronic data has been widely made. Moreover, it has been proposed to carry out various kinds of processing, in accordance with a case such as a case where the image data is to be stored in a file or a case where the image data is to be printed, with respect to image data obtained by reading a paper document, i.e., an original document.

For example, Patent Literature 1 discloses that each kind of processing is carried out, in accordance with a corresponding one of (i) a case where image data is to be outputted to a file and (ii) a case where such image data is to be printed, with respect to image data obtained by scanning, at a time, an original document with a plurality of pages. Specifically, in a case where the image data is outputted to a file, a blank page is removed. On the other hand, in a case where the image data is printed, the original document is to be printed as it is. That is, a double-sided original document is to be printed on both sides of a paper, whereas a one-sided original document is to be printed on one side of a paper. This causes no blank page to be included in the image data which has been outputted to the file. As such, it is possible to prevent an unnecessary blank page from being displayed when the image data is inspected.

### CITATION LIST

### Patent Literatures

Patent Literature 1

Japanese Patent Application Publication, Tokukai, No. 2005-354591 A (Publication Date: Jun. 14, 2004)

### SUMMARY OF INVENTION

### Technical Problem

Conventionally, in a case where a set of original documents, such as a book or an original document with a plurality of pages, are converted into electronic data, each feature of a corresponding one of the plurality of pages is extracted from image data which have been obtained by reading images of the set of original documents, and then processing is carried out with respect to each page in accordance with a corresponding feature extracted. This may cause a problem that a viewer may feel something is wrong from one page of the plurality of pages to another in a case where the image data, each of which has been subjected to corresponding processing, are viewed as the set of original documents. This is caused by, for example, the following problems.

(1) In background detection/removal processing, a degree of background removal differs from page to page, in a case where a under color differs from page to page of a set of original documents such as (i) a case where degrees to which respective pages change over time are not uniform or (ii) a case where pages with different paper qualities are mixed in the set of original documents.

(2) In color/monochrome determination processing (ACS: Auto Color Selection, automatic color selection processing), in a case where there is a page, in a set of original documents, which is monochrome (black and white) page but is determined as a color page, such a page which is erroneously determined as a color page is mixed. This causes (i) an increase in size of a file of the set of original documents and (ii) a problem, for example, that a white background of the page which has been erroneously determined as a color page may be colored depending on a degree to which the page changes over time (e.g., a degree of sunburn of the page).

(2) In color/monochrome determination processing (ACS: Auto Color Selection, automatic color selection processing), in a case where there is a page, in a set of original documents, which is monochrome page but is determined as a color page, a size of a file of the set of original documents is increased.

(3) A set of original documents are each to be outputted to a file while keeping a top-to-bottom direction of the original document of a state in which they have been scanned. As such, in a case where a set of original documents include a page whose top-to-bottom direction differs from that of the other pages, it is necessary to rotate, when the set of original documents are inspected, such a page whose top-to-bottom direction differs from that of the other pages so that the top-to-bottom direction becomes correct.

(4) In a case where a page of a set of original documents includes a blank region, a document size is not correctly recognized. This will cause the set of original documents to include such a page whose size is different.

In view of the circumstances, an object of the present invention is to provide an image processing apparatus, an image forming apparatus, a method of processing an image, a program, and a storage medium, each of which is capable of carrying out, with respect to an original document with a plurality of pages, processing in which a viewer will never feel something is wrong from one page of the plurality of pages to another.

### Solution to Problem

In order to attain the object, an image processing apparatus of the present invention is an image processing apparatus for carrying out image processing to image data based on a feature of the image data, including: a detection processing section which detects, for each page of an original document with a plurality of pages, the feature of image data of each page; a detection result calculation section which (i) accumulates the feature detected by the detection processing section and (ii) calculates a frequency of the feature of the original document; and a setting section which sets a common feature, as the feature, to the image data of the plurality of pages of the original document in accordance with the frequency calculated by the detection result calculation section.

### Advantageous Effects of Invention

With the configuration of the present invention, identical features are set, as identical types of features, with respect to a plurality of pages of an original document. It is therefore possible to prevent a viewer from feeling something is wrong from one page of the plurality of pages to another in a case where image processing is carried out in accordance with a feature of image data.

### BRIEF DESCRIPTION OF DRAWINGS

FIG. 1 is a block diagram illustrating a configuration of a digital color image forming apparatus of an embodiment of the present invention.

FIG. 2 is a block diagram illustrating a configuration employed in a case where image data is previewed by the image forming apparatus illustrated in FIG. 1.

FIG. 3 is a block diagram illustrating a configuration of the image forming apparatus illustrated in FIG. 1, which configuration is employed in a case where image data that has been read by an image input apparatus is temporarily stored in a storage device.

FIG. 4 is an explanatory diagram illustrating a histogram of input image data to be prepared in background detection processing carried out by a document type automatic discrimination section illustrated in FIG. 1.

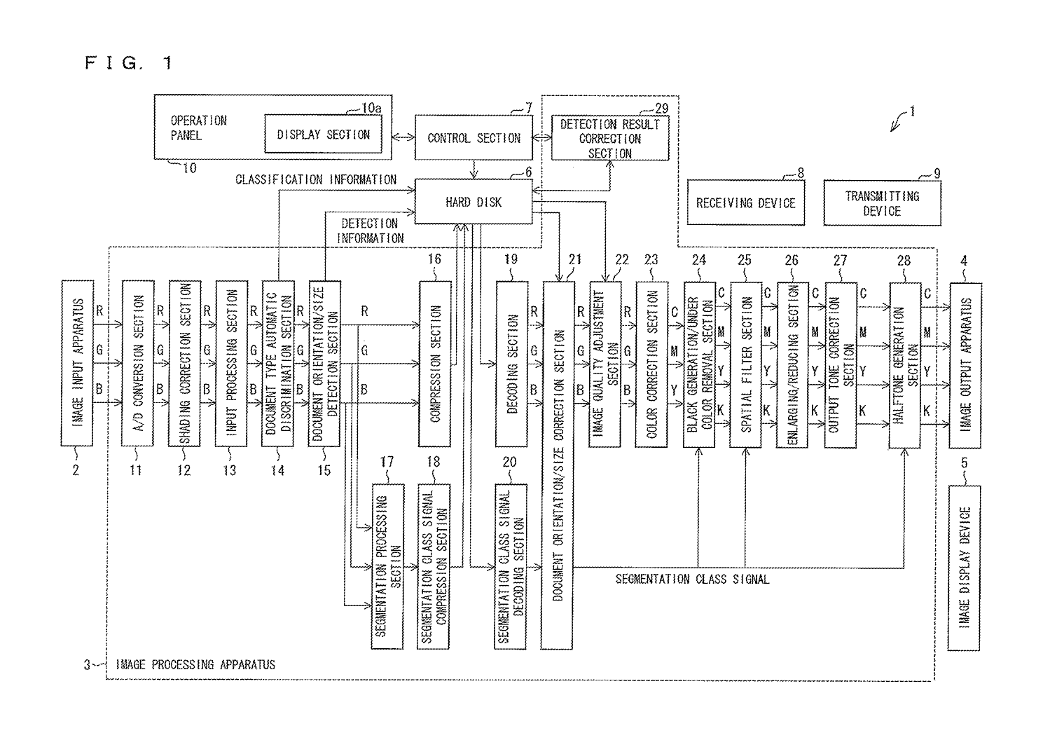

Among four histograms of FIG. 5 indicative of reliability of respective four sets of image data which (A) are prepared by a document orientation/size detection section illustrated in FIG. 1 and (B) are rotated by respective four rotation angles, (a) of FIG. 5 is an explanatory diagram illustrating a histogram indicative of a case for first image data where reliability at one rotation angle exceeds a threshold value; (b) of FIG. 5 is an explanatory diagram illustrating a histogram indicative of a case for second image data where reliability at each of the four rotation angles is lower than the threshold value; (c) of FIG. 5 is an explanatory diagram illustrating a histogram indicative of a case for third image data where reliability at each of two rotation angles exceeds the threshold value; and (d) of FIG. 5 is an explanatory diagram illustrating a histogram indicative of a case for fourth image data where reliability at each of the other two rotation angles exceeds the threshold value.

FIG. 6 is a block diagram illustrating a configuration of the document orientation/size detection section illustrated in FIG. 1.

(a) of FIG. 7 is an explanatory diagram illustrating a second coordinates information table which stores left edge coordinates, right edge coordinates, left correction edge coordinates, and right correction edge coordinates, which have been detected by an edge detection processing section illustrated in FIG. 6. (b) of FIG. 7 is an explanatory diagram illustrating a first coordinates information table which stores upper edge coordinates, lower edge coordinates, upper correction edge coordinates, and lower correction edge coordinates, which have been detected by the edge detection processing section.

FIG. 8 is an explanatory diagram illustrating a tangent/angle table which is to be used to calculate a skew of an original document in angle calculation processing in document size detection processing carried out by the document orientation/size detection section illustrated in FIG. 1.

FIG. 9 is a flow chart illustrating an operation of document region detection processing, which operation is to be performed by a document region detection section illustrated in FIG. 6.

(a) of FIG. 10 is an explanatory diagram illustrating processing carried out in S14 illustrated in FIG. 9. (b) of FIG. 10 is an explanatory diagram illustrating processing carried out in S19 illustrated in FIG. 9. (c) of FIG. 10 is an explanatory diagram illustrating processing carried out in S22 illustrated in FIG. 9.

FIG. 11 is a block diagram illustrating a configuration of a detection result correction section illustrated in FIG. 1.

(a) of FIG. 12 is an explanatory diagram illustrating a detection result reflected image and a revision selection input screen, each of which is displayed by a display section of an operation panel illustrated in FIG. 1, in automatic color selection processing. (b) of FIG. 12 is an explanatory diagram illustrating a detection result reflected image and a revision selection input screen, each of which is displayed by the display section, in background detection processing. (c) of FIG. 12 is an explanatory diagram illustrating a detection result reflected image and a revision selection input screen, each of which is displayed by the display section, in document orientation detection processing. (d) of FIG. 12 is an explanatory diagram illustrating a detection result reflected image and a revision selection input screen, each of which is displayed by the display section, in document size detection processing.

(a) of FIG. 13 is an explanatory diagram illustrating a detection result reflected image and a revision selection input screen, each of which is displayed by the display section, in blank page detection processing (blank page skip). (b) of FIG. 13 is an explanatory diagram illustrating a detection result reflected image and a revision selection input screen, each of which is displayed by the display section, in skew detection processing.

(a) of FIG. 14 is an explanatory diagram illustrating a state in which a black and white page and a color page are mixed in an original document with a plurality of pages, in color selection result calculation processing carried out by a setting section illustrated in FIG. 11. (b) of FIG. 14 is an explanatory diagram illustrating a ratio at which the black and white page and the color page are mixed in the original document. (c) of FIG. 14 is an explanatory diagram illustrating a result of the color selection result calculation processing carried out by the setting section in accordance with the ratio, illustrated in (b) of FIG. 14, at which ratio the black and white page and the color page are mixed in the original document.

FIG. 15 is a flow chart illustrating the color selection result calculation processing carried out by the setting section illustrated in FIG. 11.

(a) of FIG. 16 is an explanatory diagram illustrating a state in which pages different from each other in background detection result (a page having a background/a page having no background) are mixed in an original document with a plurality of pages, in background detection result calculation processing carried out by the setting section illustrated in FIG. 11. (b) of FIG. 16 is an explanatory diagram illustrating a ratio at which the page having a background and the page having no background are mixed in the original document. (c) of FIG. 16 is an explanatory diagram illustrating a result of the background detection result calculation processing carried out by the setting section in accordance with the ratio, illustrated in (b) of FIG. 16, at which ratio the page having a background and the page having no background are mixed in the original document. (d) of FIG. 16 is an explanatory diagram illustrating a state in which pages different from each other in background detection result (a page having a background/a page having no background) are mixed in an original document with a plurality of pages at a ratio different from that of the case illustrated in (a) of FIG. 16, in background detection result calculation processing carried out by the setting section. (e) of FIG. 16 is an explanatory diagram illustrating a ratio at which the page having a background and the page having no background are mixed in the original document illustrated in (d) of FIG. 16. (f) of FIG. 16 is an explanatory diagram illustrating a result of the background detection result calculation processing carried out by the setting section in accordance with the ratio, illustrated in (e) of FIG. 16, at which ratio the page having a background and the page having no background are mixed in the original document.

FIG. 17 is a flow chart illustrating the background detection result calculation processing carried out by the setting section illustrated in FIG. 11.

(a) of FIG. 18 is an explanatory diagram illustrating a state in which pages different from each other in document orientation detection result are mixed in an original document with a plurality of pages, in document orientation detection result calculation processing carried out by the setting section illustrated in FIG. 11. (b) of FIG. 18 is an explanatory diagram illustrating a ratio at which the pages different from each other in document orientation detection result are mixed in the original document. (c) of FIG. 18 is an explanatory diagram illustrating a result of document orientation detection result calculation processing in a first correction mode carried out by the setting section in accordance with the ratio, illustrated in (b) of FIG. 18, at which ratio the pages different from each other in document orientation detection result are mixed in the original document. (d) of FIG. 18 is an explanatory diagram illustrating a result of document orientation detection result calculation processing in a second correction mode carried out by the setting section in accordance with the ratio, illustrated in (b) of FIG. 18, at which ratio the pages different from each other in document orientation detection result are mixed in the original document.

FIG. 19 is a flow chart illustrating the document orientation detection result calculation processing carried out by the setting section illustrated in FIG. 11.

(a) of FIG. 20 is an explanatory diagram illustrating a state in which pages different from each other in document size detection result are mixed in an original document with a plurality of pages, in document size detection result calculation processing carried out by the setting section illustrated in FIG. 11. (b) of FIG. 20 is an explanatory diagram illustrating a result of the document size detection result calculation processing carried out by the setting section with respect to the document size detection result illustrated in (a) of FIG. 20. (c) of FIG. 20 is an explanatory diagram illustrating a page whose document size is correctly detected. (d) of FIG. 20 is an explanatory diagram illustrating a page whose document size is erroneously detected. (e) of FIG. 20 is an explanatory diagram illustrating another page whose document size is erroneously detected.

FIG. 21 is a flow chart illustrating the document size detection result calculation processing carried out by the setting section illustrated in FIG. 11.

FIG. 22 is a block diagram illustrating a configuration of an image quality adjustment section illustrated in FIG. 11.

FIG. 23 is an explanatory diagram illustrating a γ adjustment made by a γ conversion section illustrated in

FIG. 22.

FIG. 24 is an explanatory diagram illustrating selection screen for unified processing with respect to image data which has been read and is to be displayed by the display section of the operation panel of the image forming apparatus illustrated in FIG. 1.

FIG. 25 is an explanatory diagram illustrating a selection screen for unified processing which is carried out with respect to image data which (i) is stored in a hard disk device and (ii) is to be displayed by the display section of the operation panel of the image forming apparatus illustrated in FIG. 1.

### DESCRIPTION OF EMBODIMENTS

The following description will explain an embodiment of the present invention with reference to drawings. Note that the following description will explain, as an example, a case where (i) a configuration of the present invention is applied to a digital color image forming apparatus and (ii) image data is processed by the digital color image forming apparatus. Note, however, that the present invention is not limited to this. For example, the configuration of the present invention can be applied to a server connected to a digital color image forming apparatus via a network. In that case, it can be configured such that image data is transmitted from the digital color image forming apparatus to the server so that the server carries out processing with respect to the image data, and then the image data which has been subjected to the processing is to be received by the digital color image forming apparatus.

FIG. 1 is a block diagram illustrating a configuration of a digital color image forming apparatus (hereinafter, simply referred to as an image forming apparatus) of an embodiment of the present invention. An image forming apparatus 1 is a composite machine which has a copy function, a printer function, a facsimile transmission/reception function, and a scan to e-mail function. The image forming apparatus 1 includes an image input apparatus 2, an image processing apparatus 3, an image output apparatus (printing apparatus) 4, an image display device 5, a hard disk device 6, a control section 7, a receiving device 8, a transmitting device 9, and an operation panel (input means) 10 (see FIG. 1).

(Operation Performed when Image Data is Printed)

The following description will explain, with reference to FIG. 1, a configuration and an operation of the image forming apparatus 1 in a case where image data which has been processed by the image processing apparatus 3 is printed (copy output and print output) by the image output apparatus 4.

The image input apparatus 2 is an image reading apparatus which includes a CCD (Charge Coupled Device) line sensor. The image input apparatus 2 irradiates a document with light and then converts light reflected from the document into an electric R, G, and B (R: red, G: green, B: blue) signal. The signal is inputted to the image processing apparatus 3.

The image processing apparatus 3 includes an A/D (analog/digital) conversion section 11, a shading correction section 12, an input processing section 13, a document type automatic discrimination section 14, a document orientation/size detection section 15, a compression section 16, a segmentation processing section 17, a segmentation class signal compression section 18, a decoding section 19, a segmentation class signal decoding section 20, a document orientation/size correction section 21, an image quality adjustment section 22, a color correction section 23, a black generation/under color removal section 24, a spatial filter section 25, a enlarging/reducing section 26, an output tone correction section 27, a halftone generation section 28, and a detection result correction section 29.

Color image data (RGB analog signals) which has been inputted from the image input apparatus 2 is converted into a digital signal by the A/D conversion section 11. Then, various types of distortions each of which is generated in an illumination system, an image focusing system, and an imaging sensing system of the image input apparatus 2 are removed by the shading correction section 12. Thereafter, processing such as γ correction processing is carried out with respect to each of RGB signals by the input processing section 13.

The document type automatic discrimination section 14 carries out document type discrimination processing, in which a type of original document read by the image input apparatus 2 is discriminated in accordance with the RGB signals (RGB density signals) processed by the input processing section 13. Specifically, it is discriminated whether the original document is a text document, a printed photograph document, or a text/printed photograph document in which a text and a printed photograph are mixed.

The document type automatic discrimination section 14 carries out automatic color selection processing (ACS: Auto Color Selection, ACS processing section), in which it is discriminated, in accordance with the inputted RGB signals, whether the original document read by the image input apparatus 2 is a color document or a black and white document. The document type automatic discrimination section 14 further discriminates whether or not the original document is a blank document (serving as a blank document determination section) and detects a background (serving as background detection section). Results which have been discriminated and detected by the document type automatic discrimination section 14 are temporarily stored, as classification information, in the hard disk device 6 and are then managed as filing data.

The document orientation/size detection section 15 detects, in accordance with the inputted RGB signals (RGB signals identical to those inputted from the input processing section 13), a top-to-bottom direction, from a top side of the original document to a lower side of the original document (document orientation), of the original document, a skew, and a document size each of which has been read by the image input apparatus 2. Results (document orientation/size information) which have been detected by the document orientation/size detection section 15 are temporarily stored, as detection information, in the hard disk device 6 and are then managed as filing data.

The RGB signals inputted from the input processing section 13 are inputted to the compression section 16 and are then encoded. For example, JPEG is employed as a method of encoding.

The segmentation processing section 17 determines that each pixel of input image data (RGB signals) belongs to which kind of region. Specifically, the segmentation processing section 17 determines, for example, that each pixel belongs to a black text, a color text, or a halftone dot. A result determined by the segmentation processing section 17 is outputted as a segmentation class signal.

The segmentation class signal compression section 18 compresses a segmentation class signal inputted from the segmentation processing section 17 by, for example, MMR (Modified Modified Reed) or MR (Modified Reed), each of which is a lossless compression method. The segmentation class signal compressed is temporarily stored in the hard disk device 6. In that case, the segmentation class signal compression section 18 writes in a management table so that (i) a storage address or a data name of the compressed image data which has been processed by the compression section 16 and (ii) a storage address of a compressed segmentation class signal are in association with each other. Reading or writing of data is controlled in accordance with such an association made in the management table.

An encoding code inputted from the compression section 16 and a segmentation class signal code supplied (inputted) from the segmentation class signal compression section 18 are temporarily stored in the hard disk device 6. The encoding code and the segmentation class signal code are associated with the classification information supplied from the document type automatic discrimination section and the detection information supplied from the document orientation/size detection section 15, and are then each managed as filing data.

In accordance with the classification information (output signal of the document type automatic discrimination section 14) and the detection information (output signal of the document orientation/size detection section 15), each of which is stored, for each page, in the hard disk device 6, the detection result correction section 29 carries out detection result correction processing with respect to image data of the original document read by the image input apparatus 2. Specifically, the detection result correction section 29 finds, in accordance with the classification information and the detection information for each page, correction classification information and correction detection information, which are unified (common correction classification information and common correction detection information), on all or part of the pages of the original document read by the image input apparatus 2. The detection result correction section 29 then replaces the classification information and the detection information on each page with the correction classification information and the correction detection information, respectively.

In a case where a copy output operation or a print output operation is instructed on the image output apparatus 4, from filing data stored in the hard disk device 6, an encoding code and a corresponding segmentation class signal code are read from the hard disk device 6 and are then supplied to the decoding section 19 and the segmentation class signal decoding section 20, respectively. The classification information (the output signal of the document type automatic discrimination section 14) and the document orientation/size information (the detection information, which is the output of the document orientation/size detection section 15) are read from the hard disk device 6 and are then supplied to the image quality adjustment section 22 and the document orientation/size correction section 21, respectively.

The decoding section 19 decodes the encoding code and then decompresses the code decoded to obtain RGB image data. The segmentation class signal decoding section 29 decodes the segmentation class signal code. The RGB image data and the segmentation class signal each of which has been decoded are supplied to the document orientation/size correction section 21.

In accordance with document orientation/document size information (detection information), the document orientation/size correction section 21 carries out, with respect to the RGB image data supplied from the decoding section 19 and the segmentation class signal supplied from the segmentation class signal decoding section 20, (i) document orientation detection result correction processing (no correction, rotation processing by 90 degrees, 180 degrees, or 270 degrees) and (ii) document size detection result correction processing. The segmentation class signal, which has been corrected, is supplied to the black generation/under color removal section 24, the spatial filter section 25, and the halftone generation section 28. The sections 24, 25, and 28, to which a corrected segmentation class signal has been supplied, each select processing in accordance with various types of regions indicated by the segmentation class signal.

The image quality adjustment section 22 carries out background removal in accordance with a detection result of background which is indicated by the correction classification information. Note that the correction classification information is obtained as a result of the detection result correction section 29 correcting the classification information which has been outputted from the document type automatic discrimination section 14. In accordance with setting information that is entered by a user input from the operation panel 10 of the image forming apparatus 1, the image quality adjustment section 22 makes adjustments of RGB (color adjustments, color adjustment such as reddishness or bluishness), a brightness, and a saturation.

The color correction section 23 (i) generates CMY (C: Cyan; M: Magenta; Y: Yellow) signals, which are complementary colors of the RGB signals, from the RGB image data supplied from the image quality adjustment section 22 and then (ii) carries out, with respect to the CMY signals generated, processing in which color reproducibility is improved. The black generation/under color removal section 24 converts the CMY signals supplied from the color correction section 23 into CMYK (K: black) four-color signals. The spatial filter section 25 carries out edge enhancement processing and/or smoothing processing with respect to the CMYK signals (image data) supplied from the black generation/under color removal section 24.

In accordance with a signal (a zoom ratio with respect to an image to be printed) supplied from the operation panel 10 of the image forming apparatus 1, the enlarging/reducing section 26 carries out processing in which the image is enlarged or reduced. The output tone correction section 27 carries out γ correction processing so as to output (print) image data to a storage (recording) medium such as paper. The halftone generation section 28 carries out, with respect to image data to be printed, tone reproduction processing by error diffusion processing or dither processing.

Image data (CMYK signal) outputted from the halftone generation section 28 is supplied to the image output apparatus 4. The image output apparatus 4 outputs (prints), in accordance with the image data (CMYK signal), an image to a storage (recording) medium such as paper. Examples of the image output apparatus 4 encompass a color image output apparatus (a printing apparatus) in which an electrophotographic system or an ink-jet system is employed. Note that type of the image output apparatus 4 is not particularly limited. Note also that the processing, which has been described above, is controlled by the control section 7 including a CPU (Central Processing Unit) or a DSP (Digital Signal Processor).

The control section 7 controls, in accordance with a user input entered from the operation panel 10, an operation of each section of the image forming apparatus 1, mainly an operation of the image processing apparatus 3. The control section 7 further controls a display section 10a to perform a display operation such as an operation of displaying input screens in various formats on the display section 10a of the operation panel 10.

(Operation Performed when Image Data is Previewed)

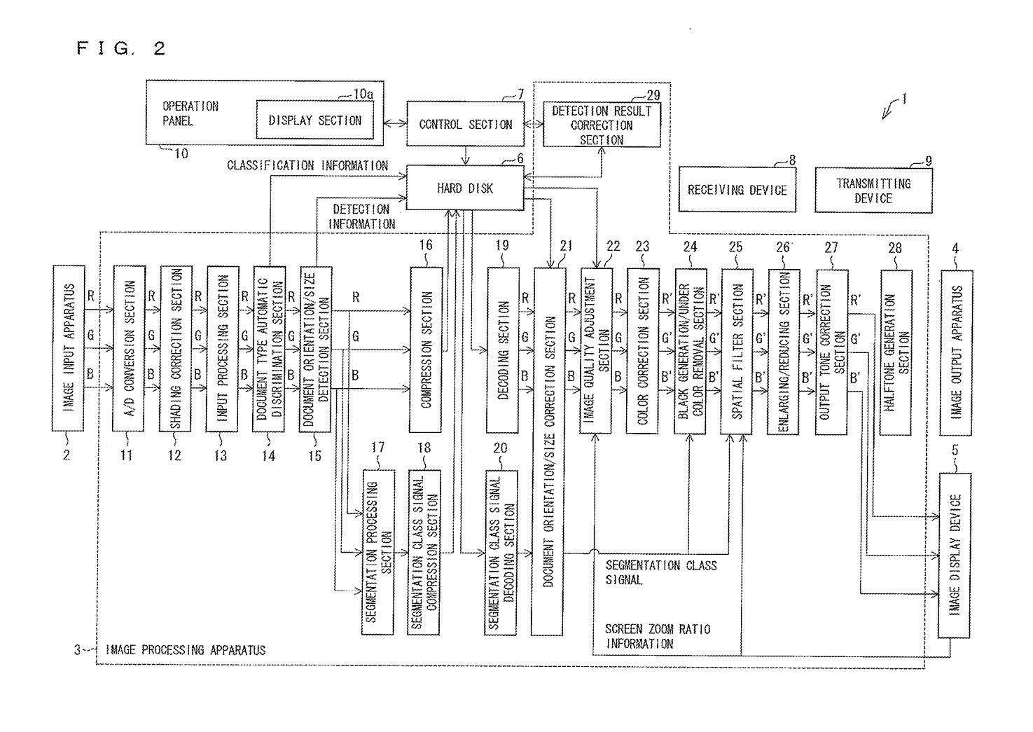

The following description will explain, with reference to FIG. 2, a case where image data, which has been processed by the image processing apparatus 3, is previewed by the image display device 5. FIG. 2 is a block diagram illustrating a configuration employed in a case where image data is previewed by the image forming apparatus 1 illustrated in FIG. 1.

Note that, since the operations performed from the A/D conversion section 11 through the image quality adjustment section 22 are identical to those to be performed when image data is printed, the description is not described repeatedly. Note also that, in a case where preview display is carried out, (i) no processing is carried out with respect to image data by the black generation/under color removal section 24 and (ii) no processing is carried out by the halftone generation section 28.

The color correction section 23 converts, in accordance with a display characteristic of the image display device 5, RGB signals supplied from the image quality adjustment section 22 into R′G′B′ signals. The spatial filter section 25 carries out edge enhancement processing and/or smoothing processing with respect to the R′G′B′ signals.

The enlarging/reducing section 26 carries out processing in which the number of pixels of an R′G′B′ signal is converted into the number of pixels of a display. The enlarging/reducing section 26 further carries out processing in which an image is enlarged or reduced in accordance with a signal which (i) is supplied from the operation panel 10 of the image forming apparatus 1 and (ii) is indicative of a display zoom ratio (e.g., a fixed zoom ratio such as 200% or 400%).

The output tone correction section 27 carries out output γ correction processing required for displaying image data by the image display device 5. The image data, which has been subjected to the processing, is supplied to the image display device 5 made up of a liquid crystal display etc.

(Operation Performed when Facsimile Transmission of Image Data is Carried Out)

The following description will explain, with reference to FIG. 2, an operation performed in a case where image data is transmitted by a facsimile function. Note that, since the operations performed from the A/D conversion section 11 through the document orientation/size correction section 21 are identical to those to be performed when image data is printed, the description is not described repeatedly.

The image quality adjustment section 22 converts inputted RGB signals into a K signal by, for example, a matrix coefficient. The image data which has been converted into the K signal is subjected to (i) processing such as edge enhancement processing by the spatial filter processing section 25, (ii) the output γ correction processing by the output tone correction processing section 27, and then (iii) binarization process by, for example, error diffusion processing on the halftone generation section 28. The binarized image data is subjected to rotation processing as needed, is compressed in a given format by a compression/decompression processing section (not illustrated), and is then stored in a memory (not illustrated).

The transmitting device 9 (e.g., a modem) carries out a transmission procedure to the destination so as to secure a transmittable state. In this state, the image data, which has been compressed in the given format, is read from the memory, is subjected to necessary processing such as conversion of compression format, and is then subjected to sequential transmission to the destination via a communication line. Note that, in a case of the facsimile transmission, (i) no processing is carried out by the color correction section 23 and the black generation/under color removal section 24 and the enlarging/reducing section 26 carries out enlarging/reducing processing with respect to the image data in accordance with a transmission resolution.

In a case where image data to be facsimile-transmitted is previewed, the process carried out from the A/D conversion section 11 through the image quality adjustment section 22 is identical to the process carried out when the facsimile transmission of image data is carried out. Specifically, with respect to the image data, no processing is carried out by the halftone generation processing section 28, and the output γ correction processing for displaying image data is carried out by the output tone correction section 27 so that the image data is displayed by the image display device 5.

A user can select, on the operation panel 10 of the image forming apparatus 1, whether the user wishes to carry out unified processing (common processing) with respect to the original documents with a plurality of pages (see FIG. 24), as to the detection result correction processing to be carried out by the detection result correction section 29, i.e., as to each of color selection result correction processing, background detection result correction processing, document orientation detection result correction processing, document size detection result correction processing, blank page skip processing, document skew correction processing, and contrast correction processing. Note that, in a correction mode, the user can specify, in the detection result correction processing, whether all the pages of the original documents are corrected in a unified manner or only an uncertain page of the original documents is corrected.

Note that the detection result correction section 29 can be alternatively configured to carry out each of the above processing in accordance with instruction inputted from the control section 7, in a case where the detection result correction section 29 accepts a user's instruction entered from the operation panel 10. With the configuration, the detection result correction section 29 can operate in a situation where the user wishes, instead of always operating. This makes it possible to eliminate useless processing on the image processing apparatus and to improve convenience of the image processing apparatus. FIG. 24 is an explanatory diagram illustrating a selection screen for unified processing with respect to image data which has been read and is to be displayed by the display section 10a of the operation panel 10 of the image forming apparatus 1. Note that a background removal level, a contrast and a correction mode will be described later.

(Scan to E-Mail Operation)

Although not particularly illustrated, in a case where an operation is performed by a scan to e-mail function, the image processing apparatus 3 causes the image quality adjustment section 22, the color correction section 23, the spatial filter section 25, and the enlarging/reducing section 26 to carry out the respective processes with respect to image data inputted from the image input apparatus 2. After the output γ correction processing is then carried out with respect to the image data by the output tone correction section 27, format conversion processing is carried out with respect to the image data and the image data is converted into, for example, a PDF file. Thereafter, an e-mail, to which the image data is attached, is transmitted to the destination via a network.

In a case where image data which is transmitted via an e-mail is previewed, the output γ correction processing for displaying the image data is carried out by the output tone correction section 27 so that the image data is displayed by the image display device 5. Note that, as with the aforementioned case, no processing is carried out by the halftone generation processing section 28. Thereafter, in a case where a user presses, for example, a read button on the operation panel 10, the image input apparatus 2 starts reading an original document.

In a case where an operation is carried out by the scan to e-mail function in the image processing apparatus 3 or in a case where unified processing is carried out with respect to image data stored in a memory device such as a USB memory, a user operates a button (not illustrated), on the operation panel 10, for selecting a unified processing mode (book scan mode). This causes a selection screen for unified processing to be displayed (see FIG. 24). The selectable operations on the selection screen for unified processing is as has been described. In a case where (i) the user makes a selection on the selection screen for unified processing and then (ii) a start button (not illustrated) on the operation panel 10 or a read button (see FIG. 24) is operated, the image input apparatus 2 starts reading an original document.

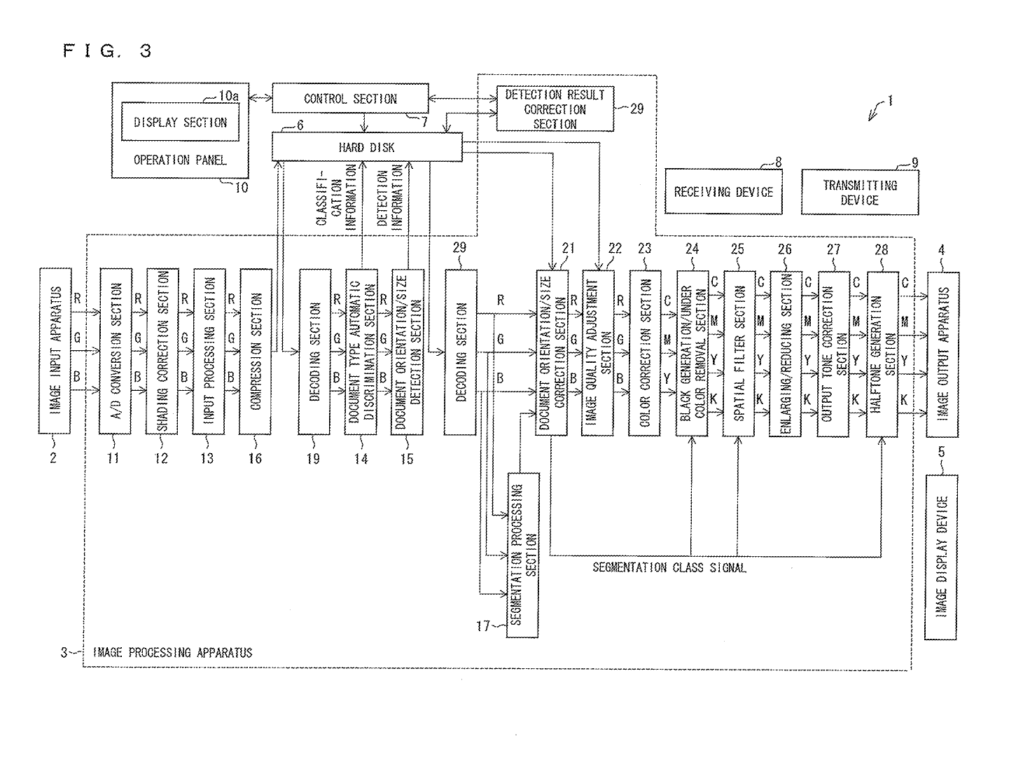

During the operations described above, (i) the image data (encoding code) compressed by the compression section 16, (ii) the document type discrimination result (classification information) outputted from the document type automatic discrimination section 14, and (iii) the document orientation/size detection result (detection information (document orientation/size detection information)) outputted from the document orientation/size detection section 15, are associated with each other and are then stored in the hard disk device 6. Note, however, that it can be alternatively configured such that image data which has been read by the image input apparatus 2 is to be temporarily stored in the storage device such as the hard disk device 6 (see FIG. 3). FIG. 3 is a block diagram illustrating a configuration of the image forming apparatus 1 illustrated in FIG. 1, which configuration is employed in a case where image data that has been read by the image input apparatus 2 is temporarily stored in the storage device.

In that case, the image data read from the hard disk device 6 is subjected to (i) decoding in the decoding section 19, (ii) the document type discrimination processing in the document type automatic discrimination section 14, (iii) the document orientation/size detection processing in the document orientation/size detection section 15, (iv) the detection result correction processing in the detection result correction section 29, (v) decoding again in the decoding section 29, and then (vi) the segmentation processing in the segmentation processing section 17.

In a case where the image data is temporarily stored in the storage device as described above, it is preferable that a selection screen, on which a user can select whether or not the unified processing mode is necessary for the image data stored in the hard disk device 6, is displayed on the display section 10a of the operation panel 10, for example. In that case, when the user operates the selection button for the unified processing mode (book scan mode) in response to the prompt, a screen illustrated in FIG. 25 is displayed on the operation panel 10. FIG. 25 is an explanatory diagram illustrating a selection screen for unified processing which is carried out with respect to the image data stored in the hard disk device 6. This allows the user to specify, on the selection screen for unified processing, a detection result to be corrected (unified).

The following description will particularly explain processing which is carried out by a main part of the image processing apparatus 3.

[Document Type Automatic Discrimination Section]

(Color/Monochrome Determination Processing (ACS Processing))

Color selection processing is automatic color selection processing in which it is determined whether an original document is a color document or a black and white document. This processing is to be carried out for carrying out image processing, with respect to each image data read from an original document, by an image forming apparatus such as a digital copying machine or a digital composite machine by a method suitable for the each image data (each original document). As such, this processing is to be carried out before image processing is carried out. Examples of a method of carrying out this processing encompass the following method.

In a case where (i) it is determined whether or not each pixel of image data of an original document is a color pixel or a monochrome pixel and (ii) a presence of a given number or more of successive color pixels is detected in an order in which pixels are provided, a part where the successive color pixels are located is recognized as a color block. In a case where a given number or more of color blocks exist in a line, such a line is counted as a color line. As a result of such processing, in a case where a given number of color lines exist in a document image, such a document image is recognized as a color image. In a case where the given number of color lines does not exist in the document image, such a document image is recognized as a monochrome image. In that case, it is possible to set in advance by many image samples, (i) a reference for the number of successive color pixels to be used to determine whether or not a color block exists, (ii) a reference for the number of color blocks to be used to determine whether or not a color line exists, and (iii) a reference for the number of color lines to be used to determine whether or not a color document exists.

According to the method described above, it is possible to determine whether or not each pixel is a color pixel or a monochrome pixel by a publicly known method such as the methods below.

(1) a Method of Comparing a Maximum Value and a Minimum Value of an RGB Signal with a Threshold Value THa

max(R,G,B)−min(R,G,B)≧THa(e.g., 20)

(2) a Method of Obtaining an Absolute Value of a Difference Between Color Components of an RGB Signal and Comparing the Absolute Value with a Threshold Value

According to another example, a maximum value and a minimum value of an RGB signal of image data is compared with a threshold value THa (e.g., 20), and then it is determined whether a pixel is chromatic or achromatic based on such a compared result. Thereafter, the number of pixels, which have been determined as being chromatic, is counted in an entire document. For example, in a case where, the number of chromatic pixels is not less than 7000, the original document is determined as a color image. The threshold value is not a ratio of the chromatic pixels with respect to the entire document but is the absolute number. This is to make it possible to determine, as a color document, an original document on a part of which a seal is affixed, even in a case where such an original document is a large-sized document, e.g., an A3-paper-size document.

According to another method of determining whether image data is chromatic or achromatic, it is possible to use a publicly known method such as a method of obtaining an absolute value of a difference between color components of an RGB signal of image data and comparing the absolute value with a threshold value. Note that a method of carrying out the color selection processing is not limited to the method described above. Any method can be employed, provided that such a method can accurately determine whether an original document is color or monochrome.

According to the image processing apparatus 3, in a case where image data is determined as a color document in the color selection processing carried out by the document type automatic discrimination section 14, image processing suitable for the color document is carried out with respect to the image data. On the other hand, in a case where the image data is determined as a black and white document, image processing suitable for the black and white document is carried out with respect to the image data. This makes it possible to obtain an optimum output image from image data of each document.

For example, in a case where the image data is determined as a color document, the image quality adjustment section 22 carries out, for example, chroma adjustment with respect to the image data. In a case where the image data is outputted as image data in a format of TIFF, PDF, JPEG, or the like, the image data is outputted in a color space such as RGB or YCbCr. On the other hand, in a case where the image data is printed to a medium such as paper, the image data is outputted as image data in a CMYK color space. In that case, the image output apparatus 4 forms an image by toner and ink in a plurality of colors on the medium such as paper.

In a case where the image data is determined as a black and white document, chroma information is deleted from the image data. In a case where the image data is outputted as image data in a format of TIFF, PDF, JPEG, or the like, the image data is outputted as image data of a component such as gray, K, or Y (luminance). On the other hand, in a case where the image data is printed to the medium such as paper, the image data is outputted as image data of a K component. In that case, the image output apparatus 4 forms an image by toner and ink in a K single color on the medium such as paper.

(Blank Document Determination Processing)

The blank document determination processing is processing in which it is determined whether or not an original document is a blank document (blank page document). In this processing, for example, a method disclosed in Japanese Patent Application Publication, Tokugan, No. 2007-264922 can be employed. The following description will particularly explain how to carry out the blank document determination processing.

(1) An average value of blocks each of which is made up of a plurality of pixels including a target pixel (e.g., 7×7 pixels) is calculated for each RGB plane (for each color component), and the average value obtained is used as a pixel value of the target pixel.

(2) A maximum density difference between the respective blocks each of which is made up of a plurality of pixels including a target pixel (e.g., 7×7 pixels) is calculated for each RGB plane (for each color component) is calculated. The maximum density difference obtained is compared with an edge determination threshold, and it is determined whether or not the target pixel of the block belongs to an edge pixel. Specifically, in a case where, out of a plurality of color components, any of the plurality of color components has a maximum density difference of not less than the edge determination threshold (e.g., 30), the target pixel is determined as the edge pixel. According to another method of determining an edge pixel, a dispersion value is calculated instead of the maximum density difference, and in a case where the dispersion value is not less than a threshold value, the target pixel is determined as the edge pixel.

(3) The number of pixels, which has been determined as the edge pixel in the step (2), is counted.

(4) The average values, for each plane (for each color component), of the target pixels, which average values have been obtained in the step (1), are compared with each other. A maximum value and a maximum difference of an average value for each color component are calculated for each target pixel, and then histograms of the maximum value and the maximum difference are generated. The number of density divisions is assumed to be, for example, 16 divisions.

(5) In a case where the edge pixel count number is more than a first determination threshold, a text region or a halftone dot region exists. As such, the original document is determined as not a blank document.

(6) In a case where the edge pixel count number obtained in the step (3) is not more than the first determination threshold (e.g., 5000), the original document is determined as a blank document or as a photograph document.

(7) In a case where the original document is determined, in the step (6), as a blank document or as a photograph document, a total value of the number of divisions in each of which a frequency value of each histogram of the maximum value and the maximum difference of the average value for each color component is more than a second determination threshold (e.g., 500) is calculated. The total value regarding the maximum value and the total value regarding the maximum difference obtained are referred to as a maximum value histogram document density width and a maximum difference histogram document density width, respectively.

(8) In a case where the maximum value histogram document density width and the maximum difference histogram document density width obtained in the step (7) are each less than a third determination threshold (e.g., 3), the original document is determined as a blank document.

In the above processing, it is determined whether or not the target pixel is an edge pixel. Alternatively, it is possible to determine whether or not an original document is a blank document by (i) calculating an average value, for each color component, of a maximum value and a maximum difference by an average value, for each color component, of blocks and (ii) generating a histogram of each of the maximum value and the maximum difference. In that case, the original document can be determined as a blank document in a case where, in addition to determination of a maximum value histogram document density width and a maximum difference histogram document density width, the number of the maximum difference histogram document density width is detected, and the maximum value histogram document density width and the maximum difference histogram document density width are each less than the third determination threshold (e.g., 3) and the number of the maximum difference histogram document density width is 1.

The method of determining a blank document is not limited to the above methods. Alternatively, it is possible to make a blank document determination by counting the pixel number of black pixels and the pixel number of white pixels and then carrying out threshold processing with respect to the pixel numbers.

(Background Detection Processing)

First, input image data, which has been inputted as RGB (R: Red; G: Green; B: Blue) signals, is converted into a luminance signal by, for example, Equation 1 below so that the input image data is separated into the luminance signal and a chrominance signal.

Yⱼ=0.30Rⱼ+0.59Gⱼ+0.11Bⱼ [Equation 1]

Yj: luminance signal of each pixel, Rj, Gj, Bj: color component of each pixel

Alternatively, it is possible to obtain a brightness signal by converting input image data into a uniform color space such as a CIEL*a*b* signal (CIE: Commission International de l'Eclairage: International Commission on Illumination; L*: brightness; a*, b*: chromaticity).

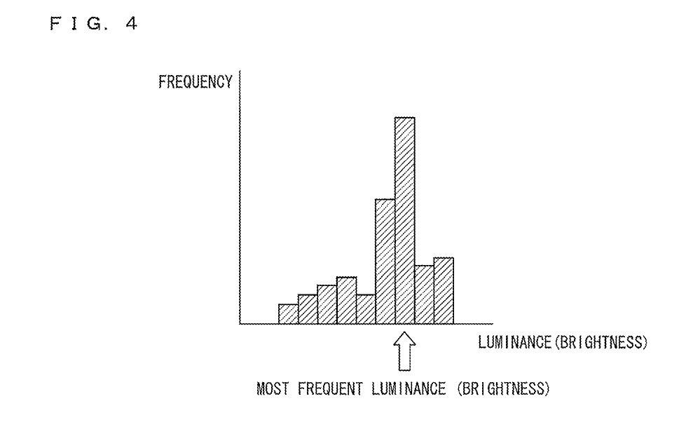

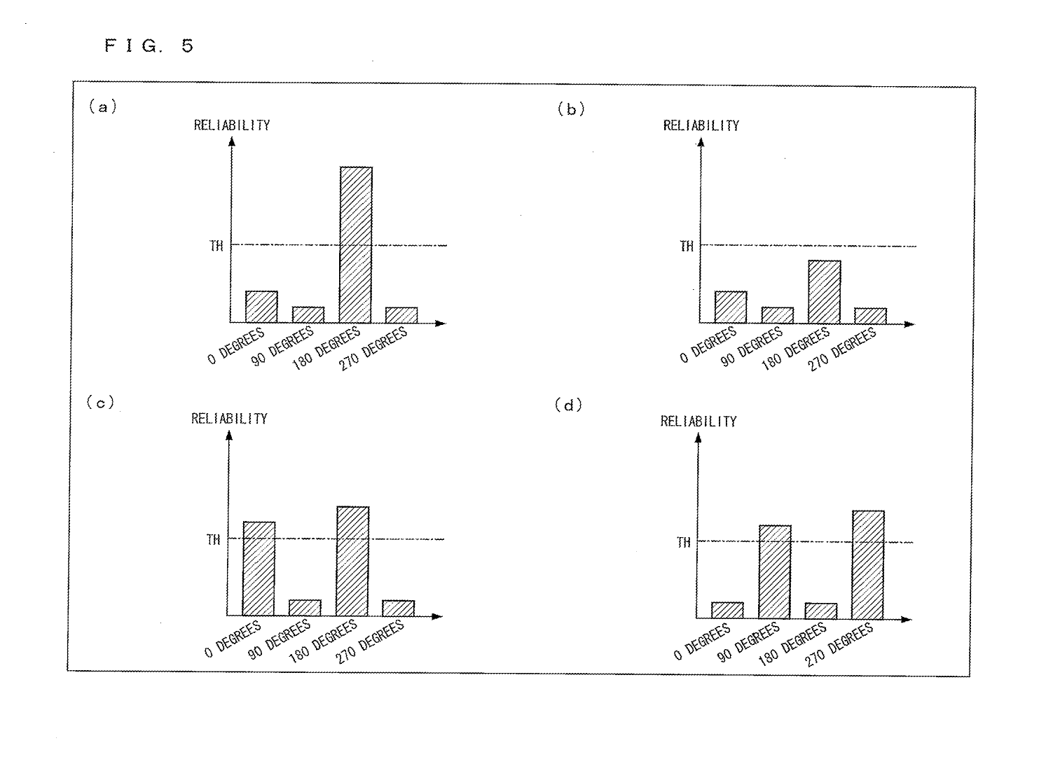

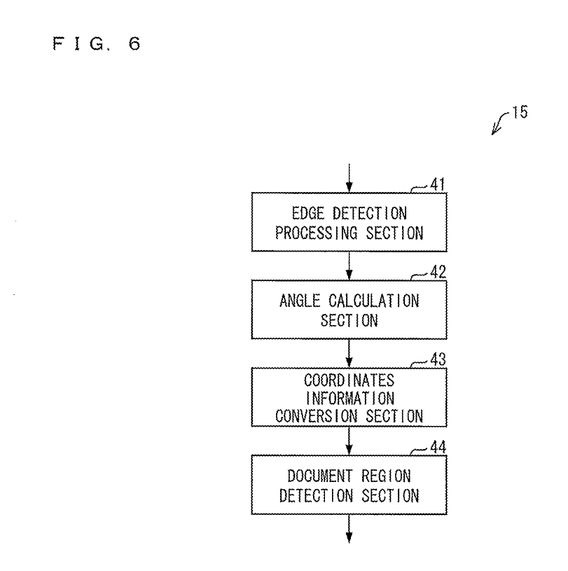

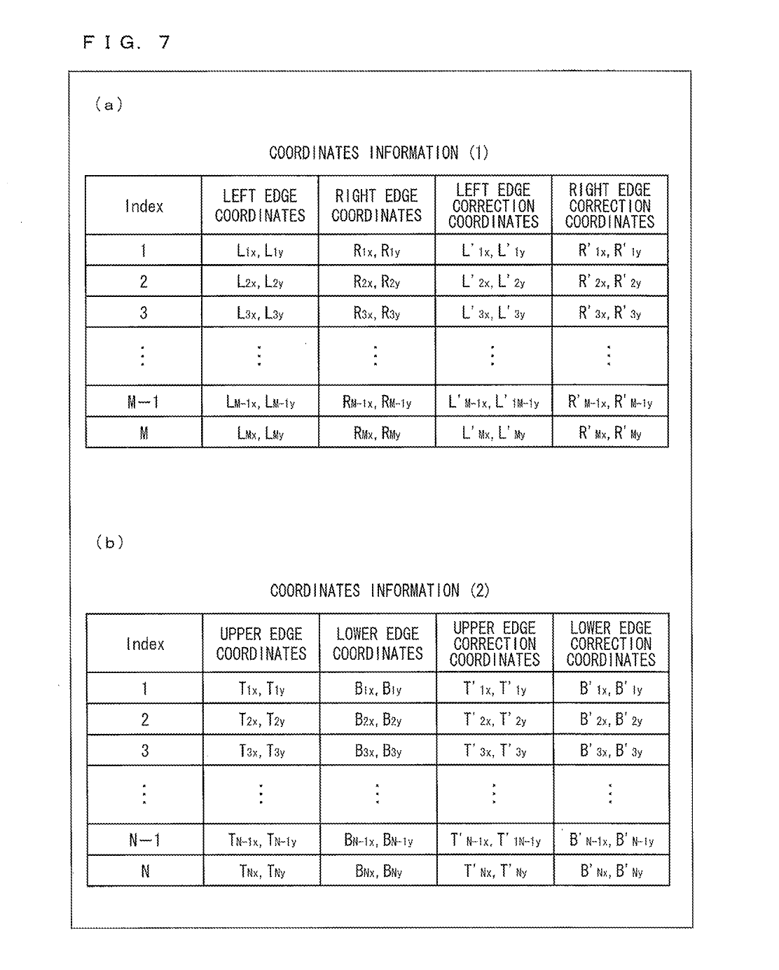

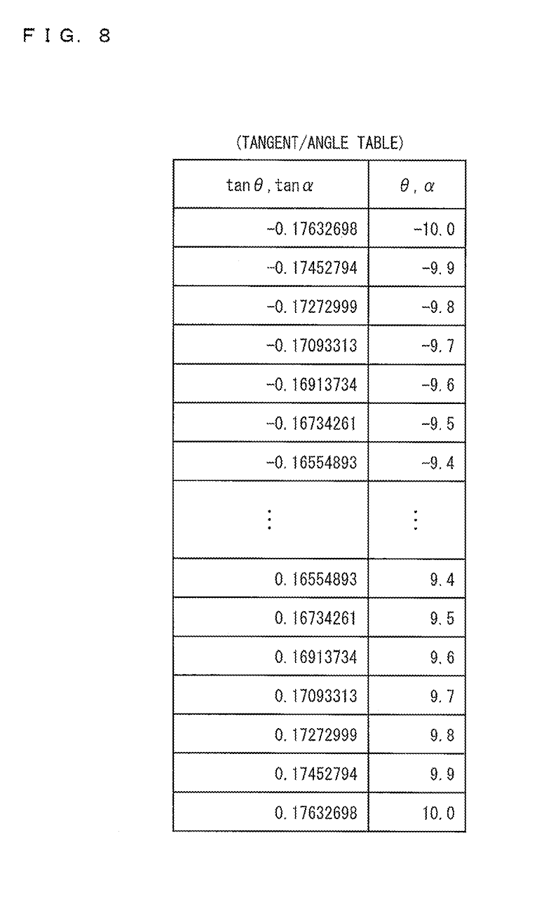

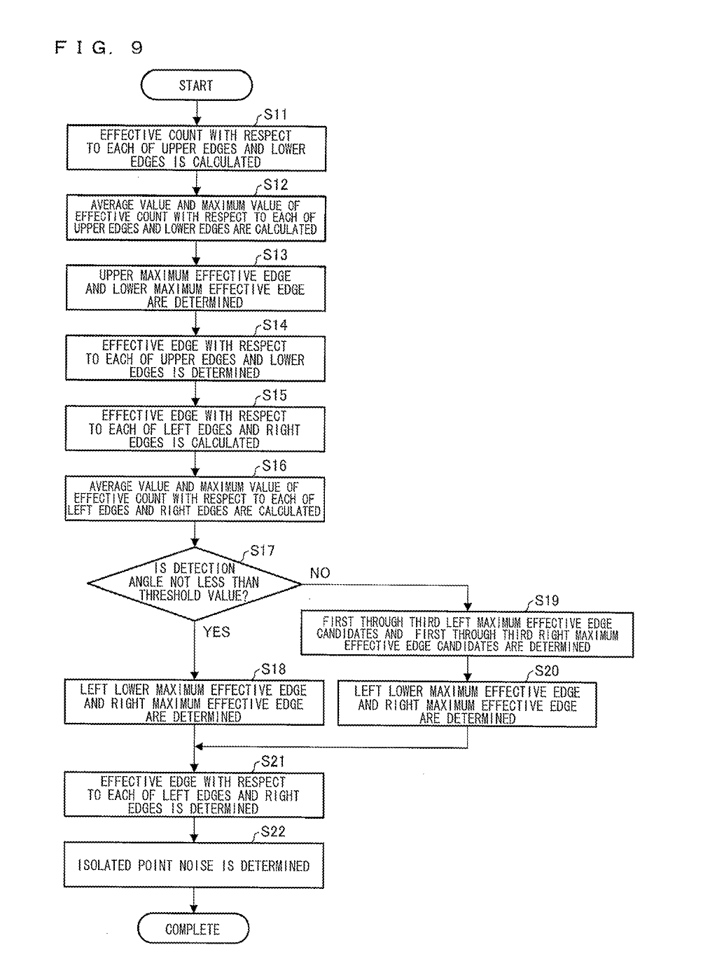

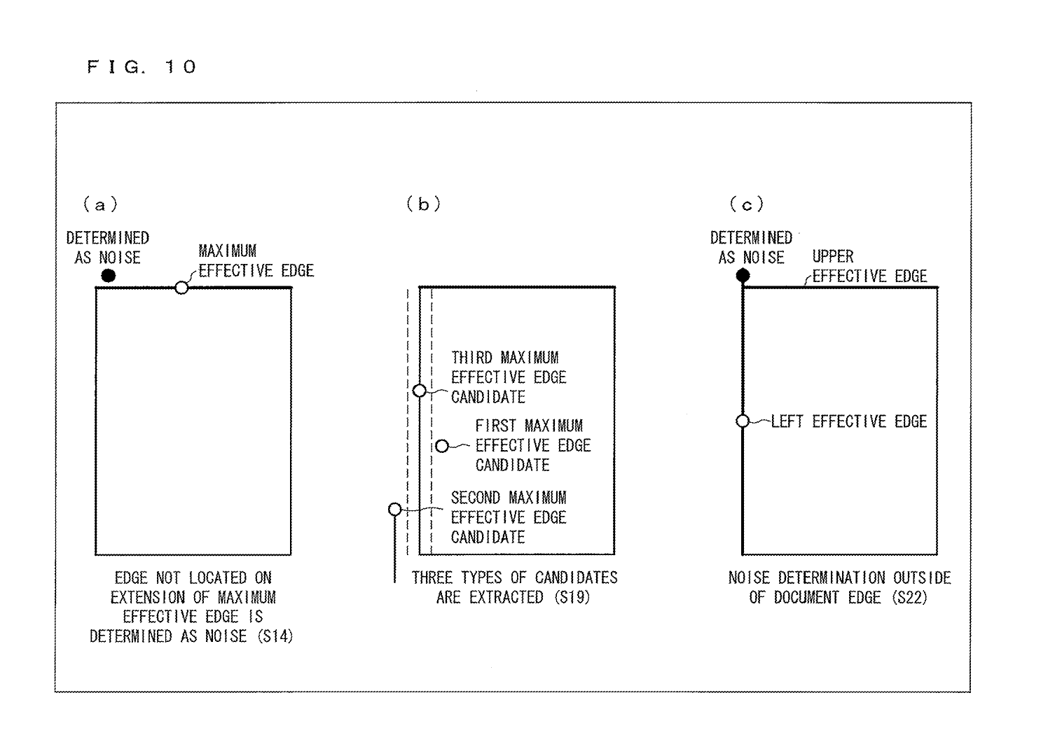

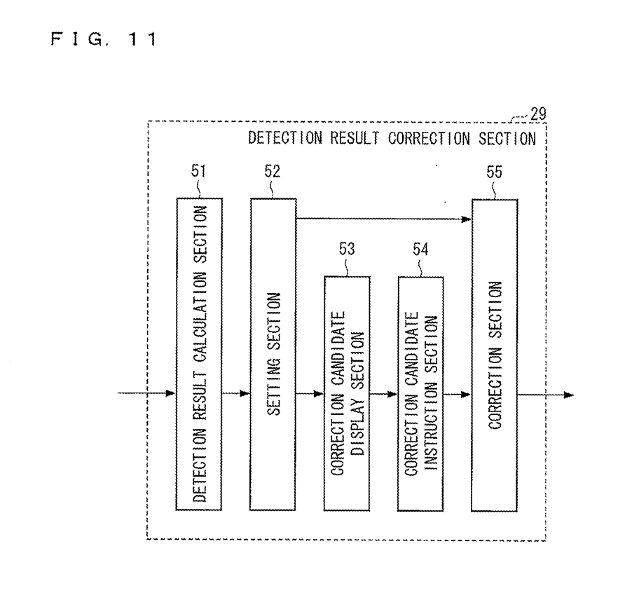

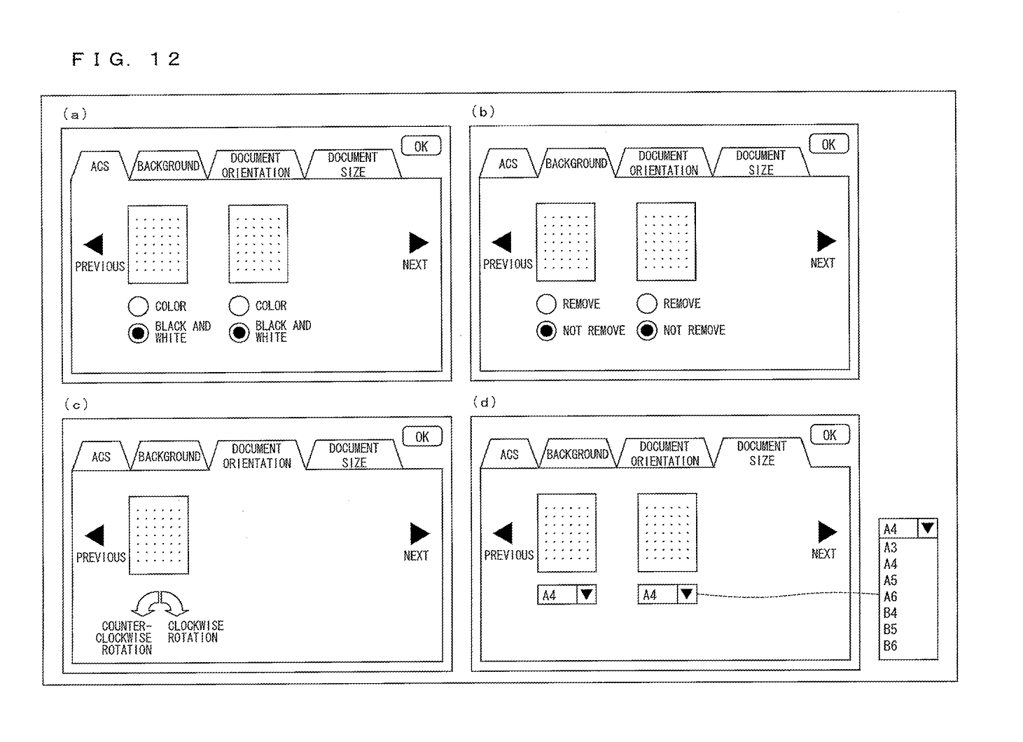

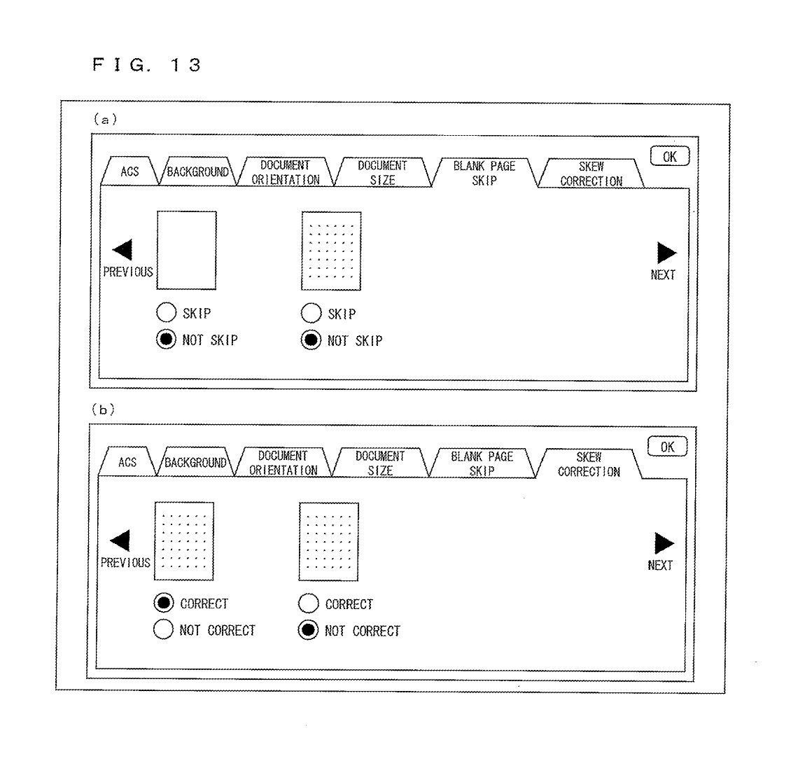

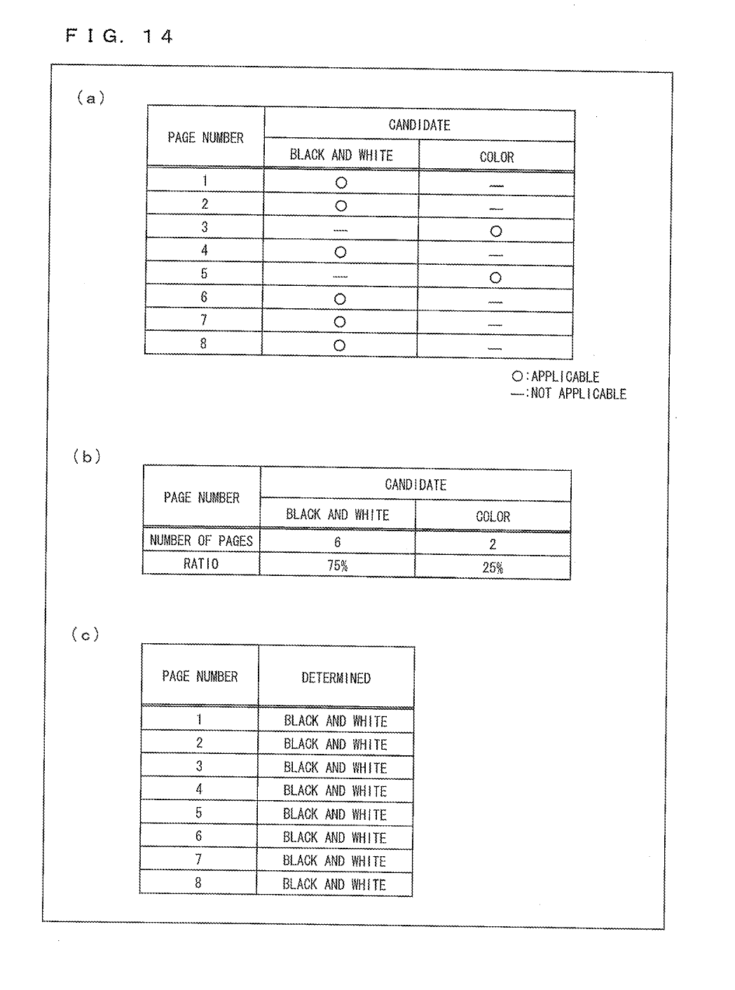

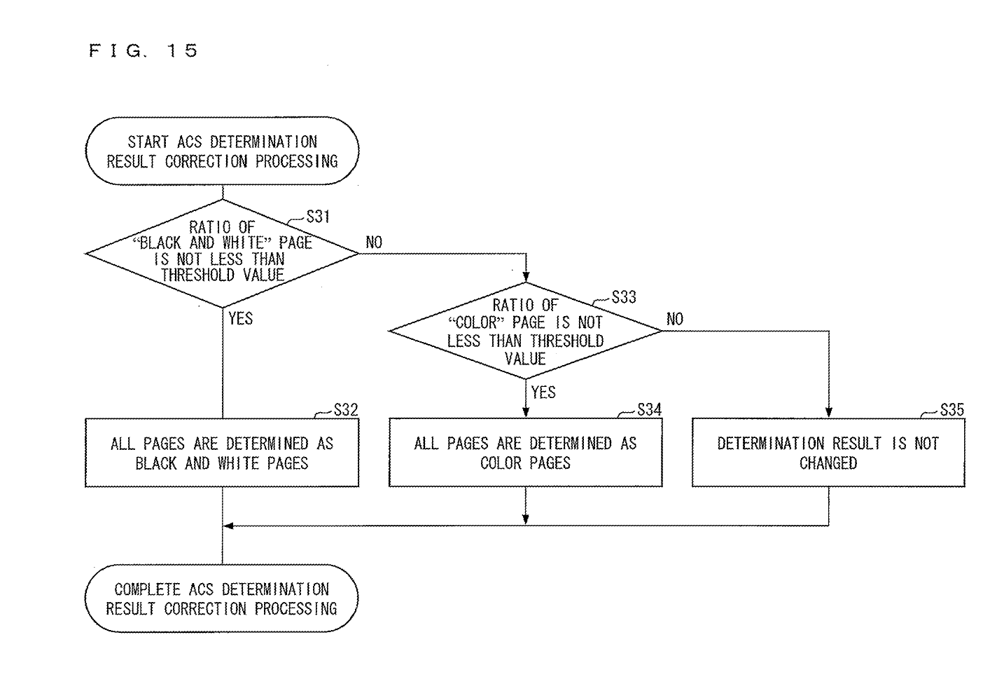

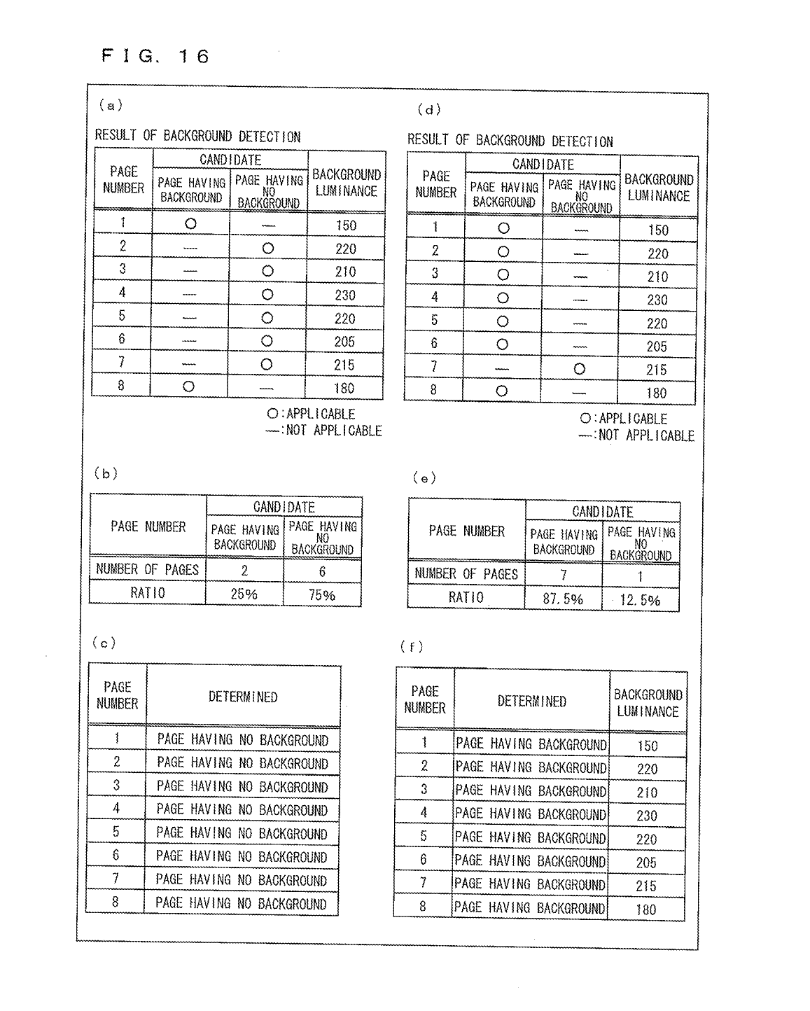

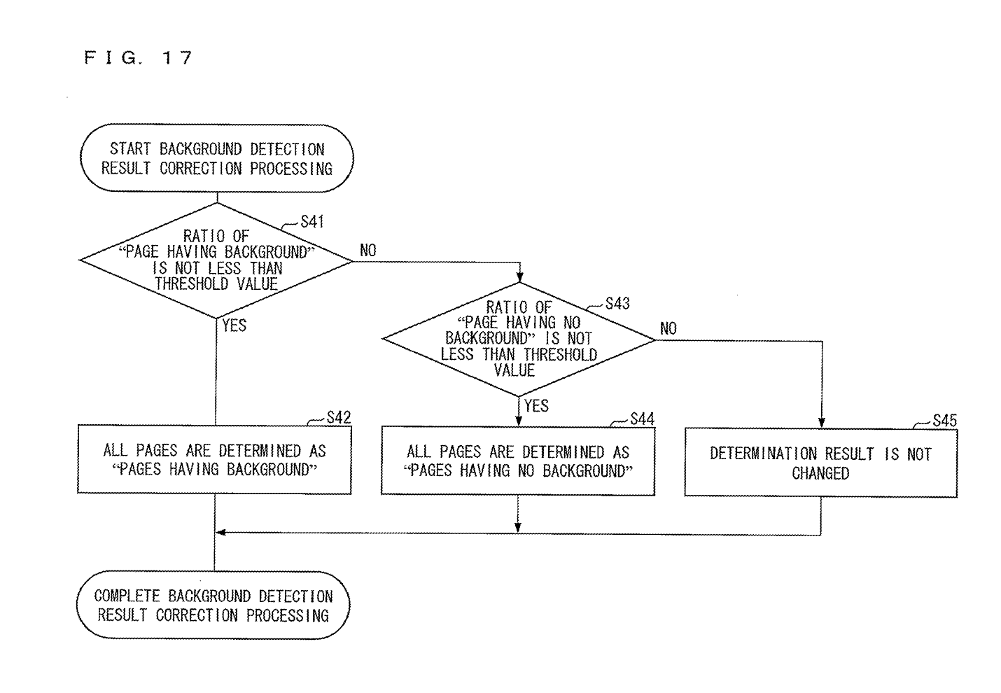

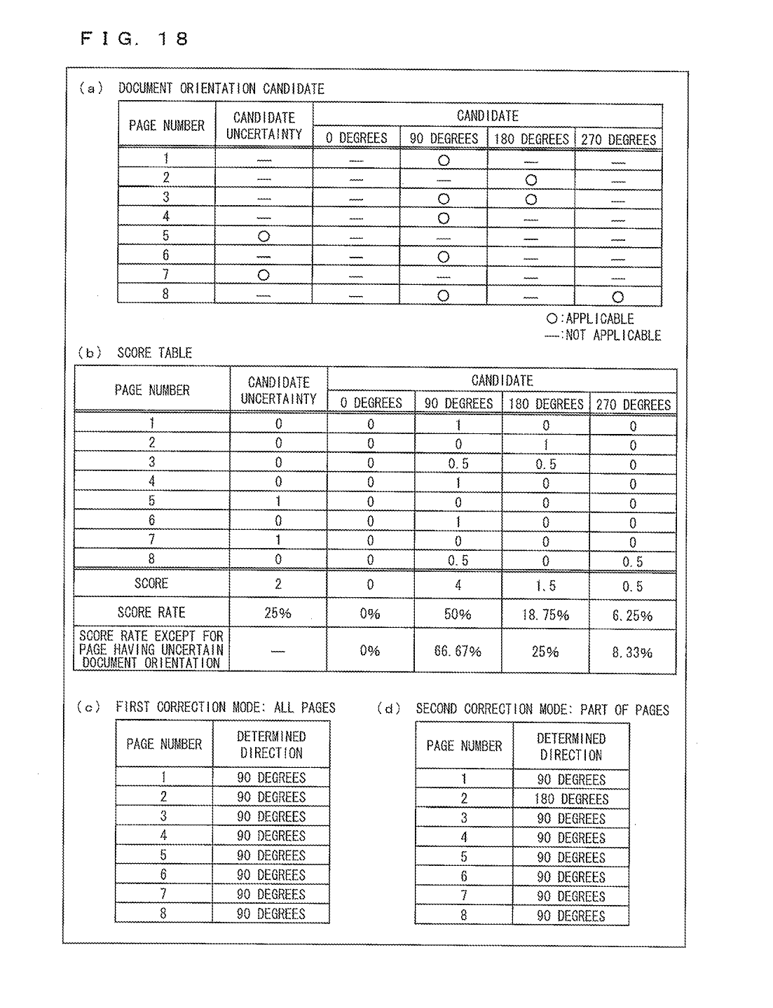

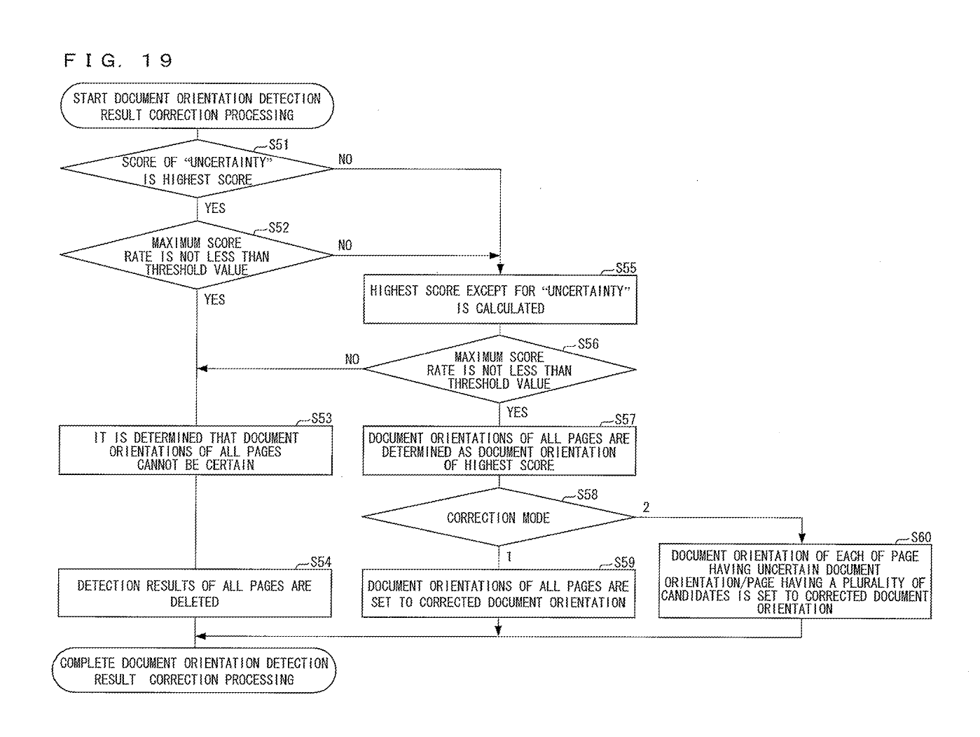

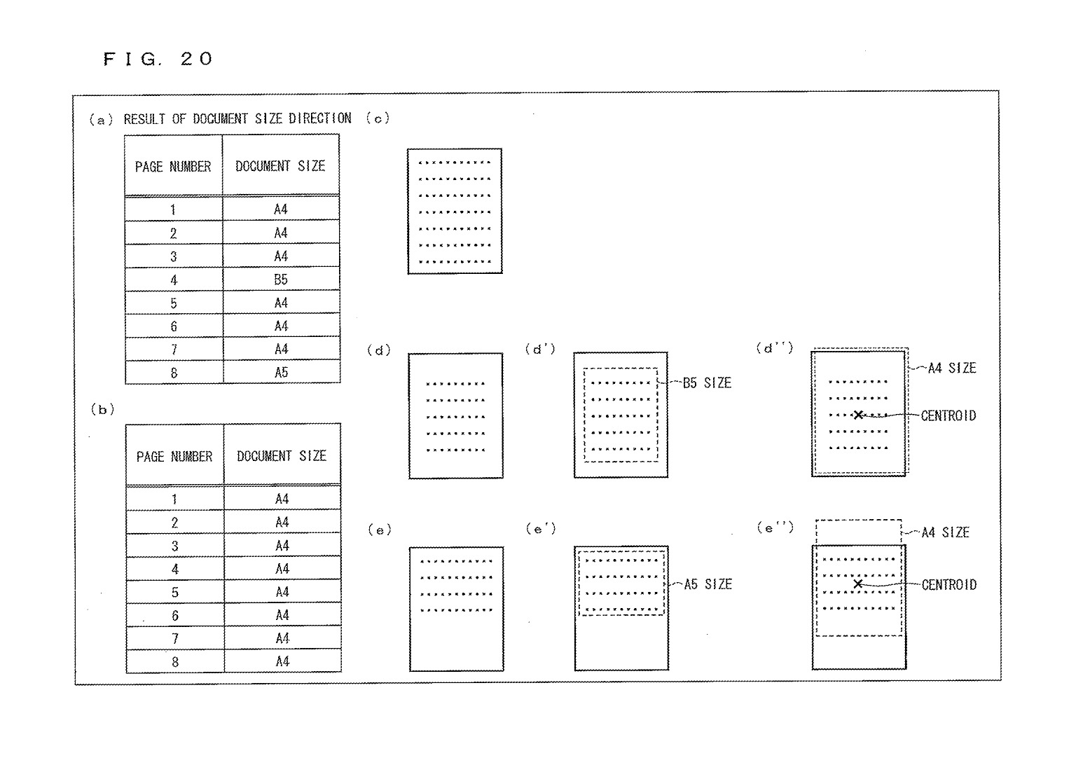

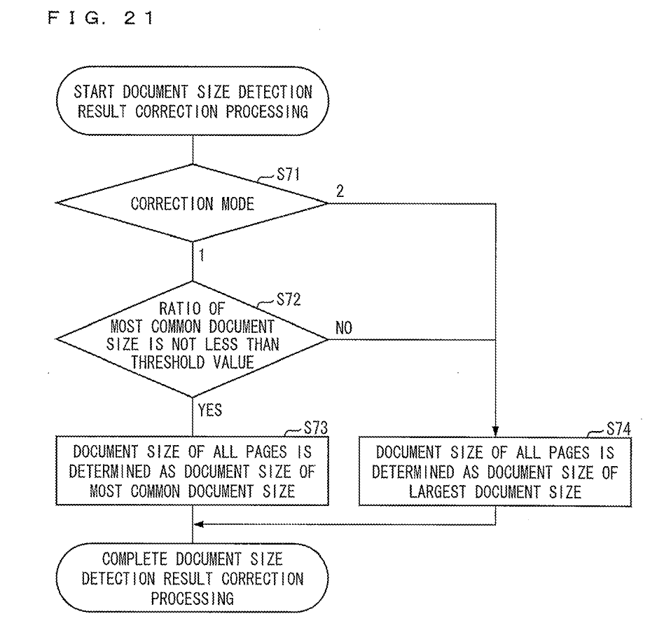

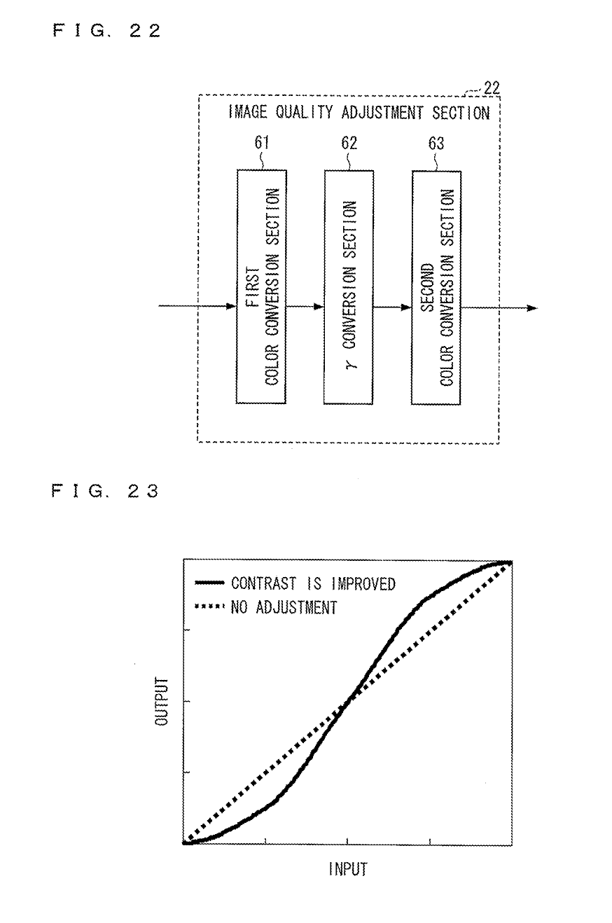

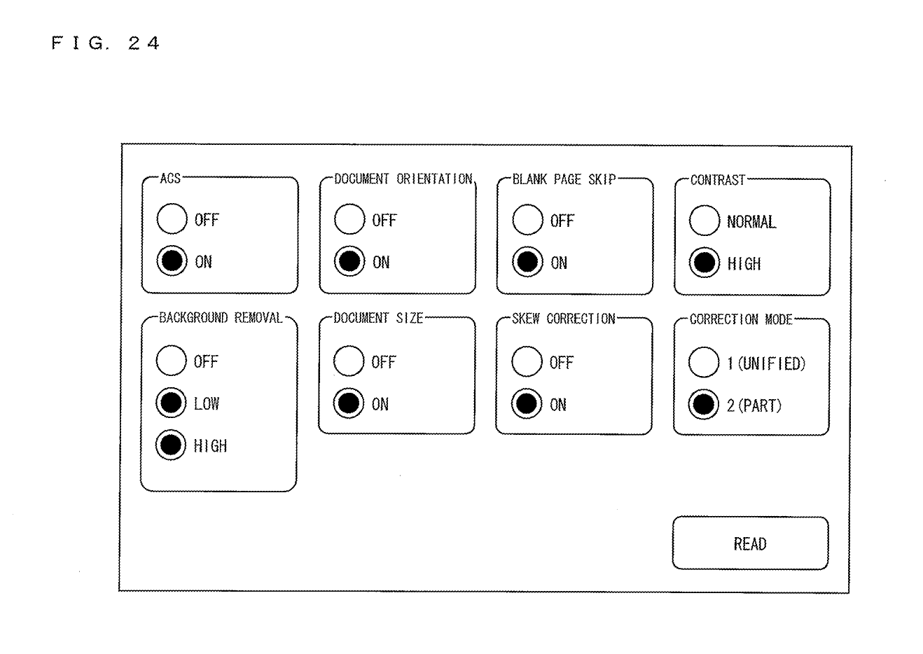

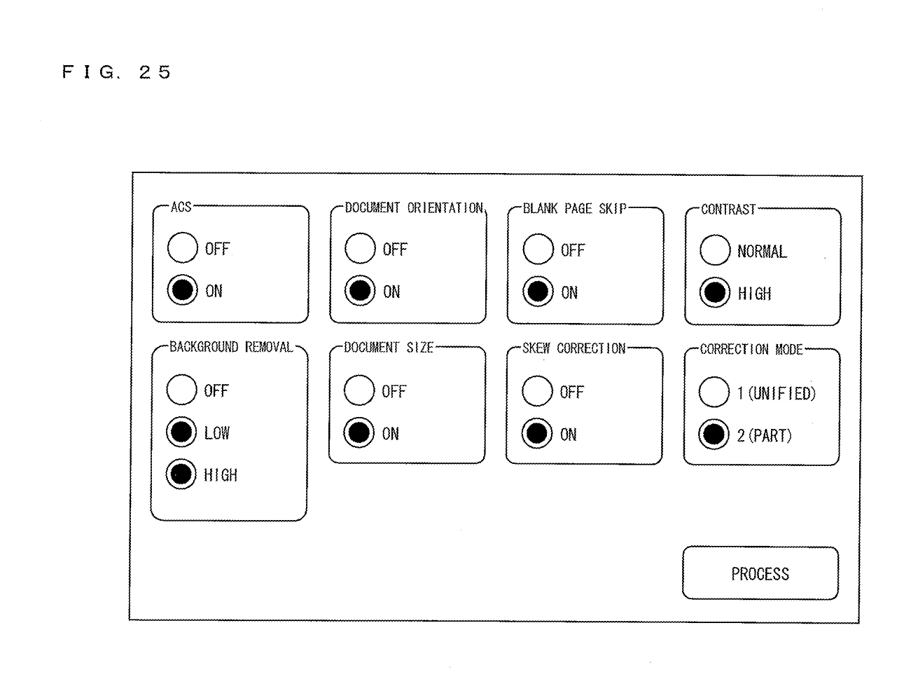

In accordance with the luminance signal or the brightness signal each of which has been obtained as described above, a histogram of an entire image is prepared (see FIG. 4). In the histogram prepared, a most frequent luminance (brightness) is considered as a background part (background density), and the luminance (brightness) Yf is compared with a predetermined threshold value th. FIG. 4 is an explanatory diagram illustrating a histogram of input image data to be prepared in the background detection processing carried out by the document type automatic discrimination section 14.

In a case where, as a result of the comparison between the luminance (brightness) Yf and the threshold value th, Yf is less than th, it is determined that the luminance of the background is less than the threshold value, i.e., it is determined that the background density exceeds the threshold value. In a case other than the above case, it is determined that the background density is not more than a given density. The threshold value can be set by a value which is obtained by checking various original documents and by which the background can be appropriately determined.

[Document Orientation/Size Detection Section]

The document orientation/size detection section 15 carries out (i) detection processing of a top-to-bottom direction of an original document and (ii) document size detection processing described below.

(Document Top-to-Bottom Direction (Document Orientation) Detection Processing)

Detection of a top-to-bottom direction of an original document can be carried out by, for example, the following method. Among four histograms of FIG. 5 indicative of reliability of respective four sets of image data which are rotated by respective four rotation angles, (a) of FIG. 5 is an explanatory diagram illustrating a histogram indicative of a case for first image data where reliability at one rotation angle exceeds a threshold value; (b) of FIG. 5 is an explanatory diagram illustrating a histogram indicative of a case for second image data where reliability at each of the four rotation angles is lower than the threshold value; (c) of FIG. 5 is an explanatory diagram illustrating a histogram indicative of a case for third image data where reliability at each of two rotation angles exceeds the threshold value; and (d) of FIG. 5 is an explanatory diagram illustrating a histogram indicative of a case for fourth image data where reliability at each of the other two rotation angles exceeds the threshold value.

(1) Rotation processing is carried out, by 90 degrees, 180 degrees, or 270 degrees, with respect to inputted image data of an original document (before the rotation processing (0 degrees)) to prepare four sets of image data including the image data of the original document which has not been subjected to the rotation processing (0 degrees).

(2) Character recognition processing (pattern matching) is carried out with respect to the four sets of image data by a dictionary so as to obtain degrees of reliability (matching scores) for the images which have been rotated by respective rotation angles of 0 degrees, 90 degrees, 180 degrees, and 270 degrees. In the character recognition processing, recognized character(s) are summed in number for each of the images rotated by 0 degrees, 90 degrees, 180 degrees, and 270 degrees. A ratio of (i) the number of recognized characters for each of the rotated images with respect to (ii) the total number of recognized characters is defined as reliability for a corresponding one of the images rotated.

(3) A threshold value TH (e.g., 70%) is set for the degrees of reliability, and each determination is made as below.

Reliability which does not exceed the threshold value is excluded.

In a case where degrees of reliability of all the four sets of image data do not exceed the TH, it is concluded that no determination can be made (uncertain) (see (b) of FIG. 5). In that case, there is no candidate.

In a case where degrees of reliability of two or more of the four sets of image data exceed the threshold value, there are a plurality of candidates. Accordingly, it is concluded that no determination can be made (uncertain) (see (c) and (d) of FIG. 5).

In a case where reliability of one of the four sets of image data exceeds the threshold value, it is determined that a state of an original document whose image data is rotated by a corresponding rotation angle is a top-to-bottom direction, from a top side of the original document to a lower side of the original document, of the original document (see (a) of FIG. 5).

(Document Size Detection Processing)

The document orientation/size detection section 15 includes an edge detection section 41, an angle calculation section 42, a coordinates information conversion section 43, and a document region detection section 44 by which operations detection processing in which a document size is detected is carried out (see FIG. 6). FIG. 6 is a block diagram illustrating a configuration of the document orientation/size detection section 15 illustrated in FIG. 1. In the document size detection processing, the following edge detection processing, angle calculation processing, coordinates information conversion processing, and document region detection processing are carried out.

(a) Edge Detection Processing

In the edge detection processing carried out by the edge detection section 41, an edge detection is carried out with respect to an inputted document image. In the edge detection, the inputted image data of an original document is reduced so as to have a given detection resolution. The purpose of changing resolution of the image data is to reduce a processing time by reducing the number of pixels of image data to be processed. This processing is carried out in a case where a “document size” correction is selected in FIG. 24. The given detection resolution is an optimum resolution for the edge detection processing (e.g., 75 dpi) and is set in advance.

Thereafter, in each line unit of the reduced image data, a position of a pixel, whose adjacent pixel has a pixel value of more than a given threshold value, is extracted as an edge. The threshold value is a value which allows a boundary between a document background and a document region to be detected. For example, in a case where a target edge to be detected is a document edge, the threshold value is set to 3. In a case where a target edge to be detected is a content edge, the threshold value is set to 20 or so.

Thereafter, the edge detection section 41 calculates leftmost pixel coordinates and rightmost pixel coordinates as left edge coordinates and right edge coordinates, respectively, when scanning is carried out, in an x-axis direction, with respect to the edge image extracted. The edge detection section 41 then stores the left edge coordinates and the right edge coordinates in a coordinates information table (coordinates information (1)) (see (a) of FIG. 7). The number of coordinates M obtained varies depending on a size of a detection resolution in a longitudinal direction. (a) of FIG. 7 is an explanatory diagram illustrating a second coordinates information table which stores left edge coordinates, right edge coordinates, left correction edge coordinates, and right correction edge coordinates, which have been detected by an edge detection processing section illustrated in FIG. 6.

Similarly, the edge detection section 41 calculates uppermost pixel coordinates and lowest pixel coordinates as upper edge coordinates and lower edge coordinates, respectively, when scanning is carried out, in a y-axis direction, with respect to the edge image extracted. The edge detection section 41 then stores the upper edge coordinates and the lower edge coordinates in a coordinates information table (coordinates information (2)) (see (b) of FIG. 7). The number of coordinates N obtained varies depending on a size of a detection resolution in a transverse direction. (b) of FIG. 7 is an explanatory diagram illustrating a first coordinates information table which stores upper edge coordinates, lower edge coordinates, upper correction edge coordinates, and lower correction edge coordinates, which have been detected by the edge detection processing section illustrated in FIG. 6.

(B) Angle Calculation Processing

In the angle calculation processing carried out by the angle calculation section 42, a skew (degree) of the original document is calculated from the edge coordinates detected by the edge detection section 41. A skew detection method disclosed in Japanese Patent Application Publication, Tokukaihei, No. 11-331547 A (1999) can be employed as the angle calculation processing.

In the angle calculation processing, a change in screw between coordinates data of respective document edges is detected from the detected edge coordinates, and points at each of which the skew changes (edge change points) are found from the change detected. Then, line segments connecting the edge change points are extracted.

Thereafter, a line segment which (i) is longest and (ii) is inclined at not more than 45 degrees with respect to an X direction (a sub scanning direction) is selected from the extracted line segments, and a skew of the original document is calculated based on start coordinates (StartEdgeX, StartEdgeY) and end coordinates (EndEdgeX, EndEdgeY) of a selected line segment.

In that case,

tan α=(EndEdgeY−StartEdgeX)/(EndEdgeX−StartEdgeX),

where α indicates a skew degree of the original document. An angle which corresponds to this value is read from, for example, a table which has been prepared in advance (see FIG. 8). FIG. 8 is an explanatory diagram illustrating a tangent/angle table which is to be used to calculate a skew of an original document in angle calculation processing in document size detection processing carried out by the document orientation/size detection section 15.

(C) Coordinates Information Conversion Processing

In the coordinates information conversion processing carried out by the coordinates information conversion section 43, coordinates information is calculated by Equation 2 below. The coordinates information is obtained in a case where all edge coordinates (EdgeX, EdgeY) which have been detected by the edge detection section 41 are each corrected by an angle calculated by the angle calculation section 42. The coordinates information calculated serves as correction edge coordinates information (CorrEdgeX, CorrEdgeY).

$$( \begin{matrix}CorrEdgeX \\ CorrEdgeY\end{matrix} ) = ( \begin{matrix}cos α & sin α \\ - sin α & cos α\end{matrix} ) ( \begin{matrix}EdgeX \\ EdgeY\end{matrix} ) \qquad [ Equation 2 ]$$

(D) Document Region Detection Processing

In the document region detection processing carried out by the document region detection section 44, the following processing is carried out by all the correction edge coordinates information calculated by the coordinates information conversion section 43.

Each upper maximum effective edge is extracted from corresponding upper edge coordinates.

Each lower maximum effective edge is extracted from corresponding lower edge coordinates.

An edge, which has upper edge coordinates that are an extension of the upper maximum effective edge is extracted as an effective edge.

As to the lower edge, similarly, an edge is extracted as an effective edge.

Three types of maximum effective edge candidates, which differ from each other in reliability, are set for each of the left edge and the right edge, and a maximum effective edge is finally extracted.

An edge which has left edge coordinates that are an extension of the left maximum effective edge is extracted as an effective edge.

As to the right edge, similarly, an edge is extracted as an effective edge.

Isolated point noise removal processing is carried out with respect to each effective edge information by peripheral effective edge information, and then a final effective edge is extracted.

The following description will explain in detail the document region detection processing with reference to FIGS. 9 and 10. FIG. 9 is a flow chart illustrating an operation of document region detection processing, which operation is to be performed by the document region detection section 44. (a) of FIG. 10 is an explanatory diagram illustrating processing carried out in S14 illustrated in FIG. 9. (b) of FIG. 10 is an explanatory diagram illustrating processing carried out in S19 illustrated in FIG. 9. (c) of FIG. 10 is an explanatory diagram illustrating processing carried out in S22 illustrated in FIG. 9.

The coordinates information conversion section 43 makes a skew correction with respect to the edge coordinates information (left edge coordinates, right edge coordinates, upper edge coordinates, and lower edge coordinates) of the original document (input image data) which edge coordinates information has been extracted by the edge detection section 41 in order to detect the size of the original document, by angle information which has been detected by the angle calculation section 42 and is indicative of a skew degree of the original document (input image data). This causes the edge coordinates information of the original document to be converted into correction edge coordinates information (left correction edge coordinates, right correction edge coordinates, upper correction edge coordinates, and lower correction edge coordinates). The document region detection section 44 extracts, in accordance with the correction edge coordinates information, an effective document edge (effective edge) in the following processing.

First, as to each of the upper correction edge coordinates and the lower correction edge coordinates, outermost correction edge coordinates located at an endmost is assumed to be target coordinates. A difference value in y coordinate between the target coordinates and respective 2ⁿ (1, 2, 4, 8, . . . )th correction edge coordinates from the target coordinates is calculated. Alternatively, a difference value in y coordinate between the target coordinates and respective 2ⁿ (4, 8, . . . )th correction edge coordinates (except for pixels adjacent to the target pixel) from the target coordinates is calculated. The number of the difference values which are not more than a threshold value (e.g., “2 pixels”) is counted, and a value counted is defined as an effective count with respect to a corresponding edge. Then, target coordinates sequentially moved to adjacent correction edge coordinates and, the processing is repeated until similar processing has been completed with respect to all the correction edge coordinates. In this way, an effective count value with respect to each of the edge coordinates is obtained (S11).

Thereafter, the following (i) and (ii) are calculated: (i) an average value of effective count values (an upper correction edge effective count average value: AveEdgeCountT, a lower correction edge effective count average value: AveEdgeCountB) and (ii) maximum effective count values (an upper correction edge maximum effective count value: MaxEdgeCountT, a lower correction edge maximum effective count value: MaxEdgeCountB) of an edge having an effective count value which is larger than an extracted effective count parameter (e.g., “2”) which is set in advance to an effective count of each of the correction edge coordinates for each of the upper correction edge and the lower correction edge (S12).

Thereafter, an edge whose y coordinate is smallest is set as an upper maximum effective edge, out of upper correction edge information which have respective effective count values of not less than the upper correction edge effective count average value (AveEdgeCountT). An edge whose y coordinate is largest is set as a lower maximum effective edge, out of lower correction edge information which have respective effective count values of not less than the lower correction edge effective count average value (AveEdgeCountB) (S13).

Thereafter, a difference between y coordinate of the correction edge coordinates of the upper maximum effective edge and respective y coordinates of the upper correction edge coordinates is calculated. In a case where the difference is not more than a set range (e.g., not more than “2 pixels”), it is determined that an upper edge is an extension of the maximum effective edge, and such an upper edge is determined as an effective edge. An edge other than the effective edge is determined as an ineffective edge (see (a) of FIG. 10). As to the lower edge, it is similarly determined whether the lower edge is an effective edge or an ineffective edge (S14).

Thereafter, as to left and right correction edge information, processing, similar to that carried out in S11, is carried out with respect to x coordinate, so that each effective count is generated with respect to corresponding edge coordinates (S15).

Thereafter, as to the left and right correction edge information, processing similar to that carried out in S12 is carried out. Thus, the following (i) and (ii) are calculated: (i) an average value of effective count values (a left correction edge effective count average value: AveEdgeCountL, a right correction edge effective count average value: AveEdgeCountR) and (ii) maximum effective count values (a left correction edge maximum effective count value: MaxEdgeCountL, a right correction edge maximum effective count value: MaxEdgeCountR) of an edge having an effective count value which is larger than an extracted effective count parameter (e.g., “2”) (S16).

Thereafter, it is determined whether or not a detection angle is not less than a threshold value (S17). In a case where the detection angle is not less than the threshold value, first document region detection processing is carried out in S18. In a case where the detection angle is less than the threshold value, second document region detection processing is carried out in S19 and S20.

In the first document region detection processing (S18), as to the left correction edge information and the right correction edge information, processing similar to that carried out in S13 is carried out and the left maximum effective edge and the right maximum effective edge are set.

In the second document region detection processing (S19), as to the left correction edge information and the right correction edge information, three types of maximum effective edge candidates (first through third maximum effective edge candidates) are set (see (b) of FIG. 10).

The first maximum effective edge candidate is set by processing similar to the first document region detection processing in S18.

An outermost edge is set as the second maximum effective edge candidate (second processing). The outermost edge is an edge which (i) is located outside of (a) an end part of an upper effective correction edge (effective edge that has been subjected to coordinates conversion (an effective correction edge)) and (b) an end part of a lower effective correction edge (effective edge that has been subjected to coordinate conversion (an effective correction edge)) and (ii) is an outermost edge of correction edge information which has a count value of not less than (A) the left correction edge effective count average value (AveEdgeCountL) and (B) the right correction edge effective count average value (AveEdgeCountR).

An outermost edge is set as the third maximum effective edge candidate (first processing). The outermost edge is an edge which (i) is located in a specific range extending around each of the end parts of the upper effective correction edge and the lower effective correction edge and (ii) is an outermost edge of correction edge information which has a count value of not less than (the left correction edge effective count average value (AveEdgeCountL) and the right correction edge effective count average value (AveEdgeCountR).

Thereafter, in S20, one of maximum effective edge candidates (left and right maximum effective edge candidates) is selected from the first through third maximum effective edge candidates (first through third left maximum effective edge candidates and first through third right maximum effective edge candidates).

In this selection, the third maximum effective edge candidate (first processing) is extracted by information of the upper and lower edges while limiting the range, so as to be information having highest reliability. Accordingly, in a case where the third maximum effective edge candidate exists, it is determined that the third maximum effective edge candidate is a maximum effective edge. Specifically, on the condition that a range, where a document region is to be detected, is limited as compared with the first document region detection processing and processing carried out by the second maximum effective edge candidate (second processing), processing carried out by the third maximum effective edge candidate (first processing) determines whether each detected edge is (i) an effective edge which can be considered as an edge of a document image or (ii) noise.

The second maximum effective edge candidate is extracted so as to include an outer edge as much as possible. This allows missing of a content to be minimized. As such, in a case where no third maximum effective edge candidate exists, it is determined that the second maximum effective edge candidate is a maximum effective edge.

The first maximum effective edge candidate is extracted so that no content is missing in the original document even in a case where no actual document edge can be extracted. As such, only in a case where neither third nor second maximum effective edge candidate exists, it is determined that the first maximum effective edge candidate is a maximum effective edge.

As has been described, an order of priority in which the first through third maximum effective edge candidates are selected is an order from the third maximum effective edge candidate, the second maximum effective edge candidate, to the first maximum effective edge candidate.

Thereafter, as to the left correction edge information and the right correction edge information each of which has been determined by the first or second document region detection processing, the processing similar to that carried out in S14 is carried out. As such, it is determined whether the left correction edge information and the right correction edge information are each an effective edge or an ineffective edge (S21).

Note that an isolated point noise may be contained in an edge which has been determined as an effective edge in S21 (see (c) of FIG. 10). In view of the circumstance, processing in which an edge which has been determined as an effective edge in S21 is redetermined whether it is an effective edge or an isolated point noise (S22).

In this processing, a determination is made with respect to the following (i) and (ii) as to whether a target edge to be processed is an effective edge or an isolated point noise, by effective edge information peripheral to an edge (a target edge to be processed), i.e., in accordance with the number of effective edges peripheral to the edge (the target edge to be processed): (i) a left edge and a right edge each of which is located outside of the upper edge and the lower edge of the original document and (ii) an upper edge and a lower edge each of which is located outside of the left edge and the right edge of the original document, out of the edges each of which has been determined as an effective edge in S21.

In the above determination, for example, in a case where the number of effective edges peripheral to a target edge is not less than a given number, such a target edge is determined as an effective edge. On the other hand, in a case where the number of effective edges peripheral to a target edge is less than the given number, such a target edge is determined as isolated point noise.

[Detection Result Correction Section]

The detection result correction section 29 includes a detection result calculation section (detection result calculation section) 51, a setting section 52, a revision candidate display section 53, a revision candidate instruction section 54, and a revision section 55 by which operations detection result correction processing is carried out (see FIG. 11). FIG. 11 is a block diagram illustrating a configuration of the detection result correction section 29. In the detection result correction processing, the following processing (i) through (iv) are carried out: (i) automatic color selection result correction processing, (ii) background detection result correction processing, (iii) document orientation detection result correction processing, and (iv) document size detection result correction processing.

Regarding all pages of an original document, the detection result calculation section 51 collects results detected by the document type automatic discrimination section 14 and the document orientation/size detection section 15, and then calculates frequencies of respective detected results. The setting section 52 determines a unified detected result with respect to the original document. A method of calculating the frequencies and a method of determining the unified detected result will be particularly explained for each detection to be determined.

The revision candidate display section 53 (i) generates a detection result reflected image in which the result of the detection result calculation processing carried out by the setting section 52 is reflected in each page of the original document and (ii) controls the display section 10a of the operation panel 10 to display the detection result reflected image. The detection result reflected image contains a display image for each of automatic color selection processing, background detection processing, document orientation detection processing, document size detection processing, blank page detection processing (blank page skip), and skew detection processing.

The revision candidate instruction section 54 accepts a user's instruction input (revision selection input) as to detection result reflected image whether or not to make a correction, as it is, with respect to a page in which the result of the detection result calculation processing is reflected and which is displayed by the detection result reflected image or to make a revision with respect to the correction. For this purpose, the revision candidate instruction section 54 controls a revision selection input screen to be displayed on the display section 10a of the operation panel 10. The revision candidate instruction section 54 supplies, to the revision section 55, a result of the user's instruction input with respect to the revision selection input screen. This allows the user to determine, with reference to the detection result reflected image, whether or not a state of the detection result calculation processing carried out with respect to each of the detected results is preferable. This ultimately allows the user to instruct, on the revision selection input screen, whether to make a correction in agreement with the detection result reflected image or to make a revision with respect to the correction.

The revision section 55 reflects the user's instruction inputted from the revision candidate instruction section 54 in the result of the detection result calculation processing which result has been inputted from the setting section 52, and then finally outputs corrected image data.

The following description will particularly explain the detection result reflected image and the revision selection input screen. (a) of FIG. 12 is an explanatory diagram illustrating a detection result reflected image and a revision selection input screen, in automatic color selection processing. (b) of FIG. 12 is an explanatory diagram illustrating a detection result reflected image and a revision selection input screen, in background detection processing. (c) of FIG. 12 is an explanatory diagram illustrating a detection result reflected image and a revision selection input screen, in document orientation detection processing. (d) of FIG. 12 is an explanatory diagram illustrating a detection result reflected image and a revision selection input screen, in document size detection processing. (a) of FIG. 13 is an explanatory diagram illustrating a detection result reflected image and a revision selection input screen, in blank page detection processing (blank page skip). (b) of FIG. 13 is an explanatory diagram illustrating a detection result reflected image and a revision selection input screen, in skew detection processing. Note that, according to the present embodiment, the detection result reflected image is displayed on the revision selection input screen.

Regarding an original document with a plurality of pages, each page which has been corrected by the setting section 52 of the detection result correction section 29 is displayed in a corresponding one of the detection result reflected images. Each revision selection input section is displayed on the revision selection input screen in accordance with a corresponding detection result reflected image of a corresponding one of the pages.

Specifically, a revision selection input section via which the user can select either “color” or “black and white” is displayed in accordance with the detection result reflected image in the color selection processing (see (a) of FIG. 12). A revision selection input section via which the user can select either “remove” or “not remove” is displayed in accordance with the detection result reflected image in the background detection processing (see (b) of FIG. 12). A revision selection input section via which the user can select either “a counterclockwise rotation” or “a clockwise rotation” is displayed in accordance with the detection result reflected image in document orientation detection processing (see (c) of FIG. 12). A revision selection input section via which the user can select a paper size is displayed in accordance with the detection result reflected image in the document size detection processing (see (d) of FIG. 12). A revision selection input section via which the user can select either “skip” or “not skip” is displayed in accordance with the detection result reflected image in the blank page detection processing (blank page skip) (see (a) of FIG. 13). A revision selection input section via which the user can select either “correct” or “not correct” regarding a skew of the original document is displayed in accordance with the detection result reflected image in the skew detection processing (see (b) of FIG. 13).

Accordingly, the user can confirm a state, in which each page is corrected, and which state is displayed in the detection result reflected image for each processing such as the color selection processing, the background detection processing, or the like. In a case where the user determines that the correction needs to be revised, the user can revise the correction page by page. The revision candidate instruction section 54 supplies, to the revision section 55, content selected by the user via each revision selection input section.

Note that, in a case where the color selection processing, the background detection processing, the document orientation detection processing, and the document size (crop) detection processing are each carried out, by a unified parameter, with respect to an original document with a plurality of pages, the use can select, before the original document is read by the image input apparatus 2, a processing mode (unified processing mode) via a selection screen for unified processing which selection screen is displayed on the display section 10a of the operation panel 10 (see FIG. 24).

Alternatively, the image forming apparatus 1 can be configured such that, in a case where each frequency of the color selection result, the background detection result, the document orientation detection result, and the document size (crop) detection result, each of which has been put together by the detection result calculation section 51, is not less than a corresponding predetermined threshold value, an inquiry is made to the user as to whether to carry out the processing with respect to the processing, whose frequency is not less than the corresponding predetermined threshold value, by the unified parameter for each page, for example, via the display section 10a of the operation panel 10. In that case, the processing is carried out, by the setting section 52, in accordance with the user input which permits the processing and is entered from the operation panel 10. Note that a display operation of the display section 10a is controlled by the control section 7.

Alternatively, the image forming apparatus 1 can be configured such that, in a case where each frequency of the color selection result, the background detection result, the document orientation detection result, and the document size (crop) detection result, each of which has been put together by the detection result calculation section 51, is not less than a corresponding predetermined threshold value, the setting section 52 carries out, with respect to the processing whose frequency is not less than the corresponding predetermined threshold value, the processing by the unified parameter for each page without making an inquiry to the user.

The image forming apparatus 1 can be configured such that, (i) even in a case where no unified skew correction is specified on the selection screen for unified processing (see FIG. 24) and (ii) in a case where the document skew detection result put together by the detection result calculation section 51 demonstrates that a page whose skew is not less than a given threshold value (e.g., not less than 1 degrees) exists at a given ratio or more (e.g., 50% or more), the user is prompted, for example, via the prompt on the display section 10a of the operation panel 10, to read again an original document so as to remove the skew. It is also possible to make an inquiry to the user as to whether to carry out the skew correction processing. Alternatively, it is possible to automatically carry out the skew correction processing with respect to a page whose skew is not less than the given threshold value (or less than the given threshold value).

(Color Selection Result Calculation Processing)

The setting section 52 carries out color selection result calculation processing in which a color selection result regarding image data of each page of an original document is put together. (a) of FIG. 14 is an explanatory diagram illustrating a state in which a black and white page and a color page are mixed in an original document with a plurality of pages (8 pages), in color selection result calculation processing carried out by the setting section 52. (b) of FIG. 14 is an explanatory diagram illustrating a ratio at which the black and white page and the color page are mixed in the original document. (c) of FIG. 14 is an explanatory diagram illustrating a result of the color selection result calculation processing carried out by the setting section 52 in accordance with the ratio, illustrated in (b) of FIG. 14, at which ratio the black and white page and the color page are mixed in the original document. FIG. 15 is a flow chart illustrating the color selection result calculation processing carried out by the setting section 52.

As illustrated in FIG. 15, the setting section 52 determines, in the color selection result calculation processing, whether or not a ratio of the black and white page is not less than a threshold value (S31). In a case where the ratio of the black and white page is not less than the threshold value, the setting section 52 determines that all pages of the original document are black and white pages (S32). In that case, all the pages of the original document are unified to the black and white pages.

On the other hand, in a case where the ratio of the black and white page is less than the threshold value in S31, the setting section 52 determines whether or not a ratio of the color page is not less than the threshold value (S33). In a case where the ratio of the color page is not less than the threshold value, the setting section 52 determines that all the pages of the original document are the color pages (S34). In that case, all the pages of the original document are unified to the color pages.

In a case where the ratio of the color page is less than the threshold value in S33, the setting section 52 does not determine that all the pages of the original document are either the black and white pages or the color pages. In this case, the pages are not unified to either the black and white pages or the color pages (S35).

In the above processing, in a case where (i) the threshold value used during the determinations in S31 and S33 is set to, for example, 70% and (ii) the ratio of the black and white page or the ratio of the color page is not less than 70%, all the pages of the original document are unified to the black and white pages or the color pages whichever is more. In a case where both of the ratio of the black and white page and the ratio of the color page are not more than the threshold value, a determination result is not corrected.

Accordingly, since in an example of the original document as is illustrated in (a) of FIG. 14, the ratio of the black and white page (75%) is not less than the threshold value (70%) (see (b) of FIG. 14), all the pages are unified to the black and white pages ((c) of FIG. 14).

(Background Detection Result Calculation Processing)

The setting section 52 carries out background detection result calculation processing in which background detection result regarding image data of each page of an original document is put together. (a) of FIG. 16 is an explanatory diagram illustrating a state in which pages different from each other in background detection result (a page having a background/a page having no background) are mixed in an original document with a plurality of pages (8 pages), in background detection result calculation processing carried out by the setting section 52. (b) of FIG. 16 is an explanatory diagram illustrating a ratio at which the page having a background and the page having no background are mixed in the original document. (c) of FIG. 16 is an explanatory diagram illustrating a result of the background detection result calculation processing carried out by the setting section 52 in accordance with the ratio, illustrated in (b) of FIG. 16, at which ratio the page having a background and the page having no background are mixed in the original document. (d) of FIG. 16 is an explanatory diagram illustrating a state in which pages different from each other in background detection result (a page having a background/a page having no background) are mixed in an original document with a plurality of pages (8 pages) at a ratio different from that of the case illustrated in (a) of FIG. 16, in background detection result calculation processing carried out by the setting section 52. (e) of FIG. 16 is an explanatory diagram illustrating a ratio at which the page having a background and the page having no background are mixed in the original document illustrated in (d) of FIG. 16. (f) of FIG. 16 is an explanatory diagram illustrating a result of the background detection result calculation processing carried out by the setting section 52 in accordance with the ratio, illustrated in (e) of FIG. 16, at which ratio the page having a background and the page having no background are mixed in the original document. FIG. 17 is a flow chart illustrating the background detection result calculation processing carried out by the setting section 52.

As illustrated in FIG. 17, the setting section 52 determines, in the background detection result calculation processing, whether or not a ratio of the page having a background is not less than a threshold value (S41). In a case where the ratio of the page having a background is not less than the threshold value, the setting section 52 determines that all pages of the original document are the pages each having a background (S42). In that case, all the pages of the original document are unified to the pages each having a background.

On the other hand, in a case where the ratio of the page having a background is less than the threshold value in S41, the setting section 52 determines whether or not a ratio of the page having no background is not less than the threshold value (S43). In a case where the ratio of the page having no background is not less than the threshold value, the setting section 52 determines that all the pages of the original document are the pages each having no background (S44). In that case, all the pages of the original document are unified to the pages each having no background.

In a case where the ratio of the page having no background is less than the threshold value in S43, the setting section 52 does not determine that all the pages of the original document are either the pages each having a background or the pages each having no background. In this case, the pages are not unified to either the pages each having a background or the pages each having no background (S45).

In the above processing, in a case where (i) the threshold value used during the determinations in S41 and S43 is set to, for example, 70% and (ii) the ratio of the page having a background or the ratio of the page having no background is not less than 70%, all the pages of the original document are unified to the pages having a background or the pages having no background whichever are more. In a case where both of the ratio of the page having a background and the ratio of the page having no background are not more than the threshold value, a determination result is not corrected.

Accordingly, in an example of an original document as is illustrated in (a) of FIG. 16, the ratio of the page having no background (75%) is not less than the threshold value (70%) (see (b) of FIG. 16), all the pages are unified to the pages each having no background ((c) of FIG. 16).

In contrast, in an example of an original document as is illustrated in (d) of FIG. 16, the ratio of the page having a background (87.5%) is not less than the threshold value (70%) (see (e) of FIG. 16), all the pages are unified to the pages each having a background ((d) of FIG. 16).

(Document Orientation Detection Result Calculation Processing)

The setting section 52 carries out document orientation detection result calculation processing in which a document orientation detection result regarding image data of each page of an original document is put together. (a) of FIG. 18 is an explanatory diagram illustrating a state in which pages different from each other in document orientation detection result are mixed in an original document with a plurality of pages (8 pages), in document orientation detection result calculation processing carried out by the setting section 52. (b) of FIG. 18 is an explanatory diagram illustrating a ratio at which the pages different from each other in document orientation detection result are mixed in the original document. (c) of FIG. 18 is an explanatory diagram illustrating a result of document orientation detection result calculation processing in a first correction mode carried out by the setting section 52 in accordance with the ratio, illustrated in (b) of FIG. 18, at which ratio the pages different from each other in document orientation detection result are mixed in the original document. (d) of FIG. 18 is an explanatory diagram illustrating a result of document orientation detection result calculation processing in a second correction mode carried out by the setting section 52 in accordance with the ratio, illustrated in (b) of FIG. 18, at which ratio the pages different from each other in document orientation detection result are mixed in the original document. FIG. 19 is a flow chart illustrating the document orientation detection result calculation processing carried out by the setting section 52.

In (a) of FIG. 18, candidate uncertainty indicates a case where reliability is lower than the threshold value (see (b) of FIG. 5). In (b) of FIG. 18, a score is 1 in a case where only one candidate for a document orientation exists. In a case where a plurality of candidates for the document orientation exist, a score will be obtained by dividing 1 by the number of the plurality of candidates. A score rate is obtained by dividing a score by the number of pages of an original document. Note that, in a case where a plurality of candidates exist, instead of equally dividing the score by the number of candidates, it is possible to proportionally divide the score by a ratio of degrees of reliability in the orientation detection processing.

Note here that the first correction mode is a mode in which document orientations of respective all pages of an original document are caused to be aligned. In the first correction mode, in a case where the document orientation of the entire document can be identified as a single orientation on the basis of the document orientations of respective all pages contained in the original document, the document orientation is unified to such a single orientation identified ((c) of FIG. 18). In a case where the document orientation of the entire original document is not identified as a single orientation, the detection results regarding the document orientations of respective all the pages are decimated. The first correction mode is suitable for a case where an original document is easier to handle when orientations of respective all pages of the original document are aligned (e.g., a book).

The second correction mode is a mode in which a state, where only document orientations of a part of pages of an original document are aligned, is permitted. That is, in a case where a page has only one candidate for a document orientation, it is determined that a document orientation, of the candidate is a document orientation of the original document. On the other hand, in a case where (i) a page having uncertain document orientation or (ii) a page has a plurality of candidates for the document orientation exist, it is determined that the most common document orientation, out of pages whose document orientations have been identified, is a document orientation of those pages ((d) of FIG. 18). The second correction mode is suitable for processing (i) an original document whose document orientation cannot be detected (e.g., a blank page or a photograph) and (ii) an original document in which orientations of characters are not uniform, so that a document orientation of the original document cannot be identified.

In the document orientation detection result calculation processing, the setting section 52 determines whether or not a score of uncertainty of document orientation is a highest score (S51). In a case where the score of uncertainty is the highest score, the setting section 52 determines whether or not a score rate of the uncertainty is not less than a given threshold value (S52) (see FIG. 19).

In a case where the score rate is not less than the given threshold value in S52, it is determined that correction orientations of all the respective pages with respect to the document orientations cannot be certain (S53). As such, the detection results of all the pages regarding the document orientations are decimated (S54), and the processing ends.

On the other hand, in a case where (i) the score of uncertainty of document orientation is not the highest score in S51 and (ii) the score rate of uncertainty is less than the given threshold value in S52, a highest score of the document orientation is calculated, except for the page having uncertain document orientation (S55).

Thereafter, the setting section 52 determines whether or not the score rate of the highest score obtained is not less than the given threshold value (S56). In a case where the score rate of the highest score is less than the threshold value, the processing proceeds to S53. On the other hand, in a case where the score rate of the highest score is not less than the threshold value, the document orientation is unified to the document orientation of the highest score (S57).

In a case where a set correction mode is the first correction mode (S58), the document orientations of all the respective pages are unified to the orientation obtained in S57 (S59). On the other hand, in a case where the set correction mode is the second correction mode in S58, (i) a document orientation of a page having uncertain document orientation and (ii) a document orientation of a page having a plurality of candidates for the document orientation, are unified to the orientation obtained in S57 (S60).

In the above processing, in a case where the threshold value used during the determinations in respective S52 and S56 is, for example, 60% and the highest score rate of the document orientation of the plurality of pages of an original document is not less than 60%, except for the page having uncertain document orientation, it is determined that such a document orientation is a correction orientation. The document orientations of all the respective pages of the original document are unified to the correction orientation (first correction mode). Alternatively, (i) the document orientation of the page having uncertain document orientation and (ii) the document orientation of the page having a plurality of candidates for the document orientation, are set to the correction orientation (second correction mode).

Accordingly, in an example of an original document as is illustrated in (a) of FIG. 18, a highest score rate (66.67%) of the document orientation, except for the page having uncertain document orientation, is not less than the threshold value (60%) ((b) of FIG. 18), in the first correction mode, the document orientations of all the respective pages are unified to the correction orientation ((c) of FIG. 18). In the second correction mode, on the other hand, (i) the document orientation of the page having uncertain document orientation and (ii) the document orientation of the page having a plurality of candidates for the document orientation, are set to the correction orientation.

(Document Size Detection Result Calculation Processing)

The setting section 52 carries out document orientation detection result calculation processing in which a document size detection result regarding image data of each page of an original document is put together. (a) of FIG. 20 is an explanatory diagram illustrating a state in which pages different from each other in document size detection result are mixed in an original document with a plurality of pages (8 pages), in document size detection result calculation processing carried out by the setting section 52. (b) of FIG. 20 is an explanatory diagram illustrating a result of the document size detection result calculation processing carried out by the setting section 52 with respect to the document size detection result illustrated in (a) of FIG. 20. (c) of FIG. 20 is an explanatory diagram illustrating a page whose document size is correctly detected. (d) of FIG. 20 is an explanatory diagram illustrating a page whose document size is erroneously detected. (e) of FIG. 20 is an explanatory diagram illustrating another page whose document size is erroneously detected. FIG. 21 is a flow chart illustrating the document size detection result calculation processing carried out by the setting section 52.

The document size is erroneously detected in (d) of FIG. 20. This is because a size of a region in which an image is formed becomes considerably small (a blank region is large) with respect to the document size, so that the image region is detected as the document size. In that case, an A4-sized page is erroneously detected as, for example, a B5-sized page, which is smaller than an actual size of the page (corresponding to a fourth page illustrated in (a) of FIG. 20). The document size is erroneously detected in (e) of FIG. 20. This is because a region in which an image is formed is deviated, upward, with respect to the document size and such an image region is detected as the document size. In that case, an A4-sized page is erroneously detected as, for example, an A5-sized page, which is smaller than an actual size of the page (corresponding to an eighth page illustrated in (a) of FIG. 20).

The setting section 52 first determines, in the document size detection result correction processing, whether or not a set correction mode is whether the first correction mode or the second correction mode (S71) (see FIG. 21).

In a case where it is determined that the first correction mode has been set, the setting section 52 determines, in the document size detection result, whether or not a ratio of the most common document size, out of the document sizes of the respective pages of an original document, is not less than a given threshold value (S72). In a case where the ratio of the most common document size is not less than the given threshold value, it is determined that the document size of all the pages of the original document is the document size of the most common document size (S73).

On the other hand, in a case where (i) it is determined in S71 that the second correction mode has been set and (ii) it is determined in S72 that the ratio of the most common document size is less than the given threshold value, it is determined that the document sizes of all the pages of the original document are a maximum document size out of the document sizes of all the pages of the original document (S74).

In the above processing, in a case where the threshold value used during the determination in S72 is, for example, 60% and the first correction mode has been set, when the ratio of the most common document size, out of the document sizes of the pages of the original document, is not less than 60%, it is determined that the document sizes of all the pages of the original document are the most common document size. On the other hand, in a case where the ratio of the most common document size is less than 60%, it is determined that the document sizes of all the pages of the original document are the maximum document size out of the document sizes of all the pages of the original document.

Accordingly, in an example of an original document as is illustrated in (a) of FIG. 20, the ratio of the most common document size (75%) is not less than the threshold value (60%). As such, document sizes of all pages are unified to the A4-size ((b) of FIG. 20, a rightmost drawing in (d) of FIG. 21, a rightmost drawing in (e) of FIG. 21).

[Image Quality Adjustment Section]

The image quality adjustment section 22 carries out the following background removal processing and RGB saturation adjustment processing.

(Background Removal Processing)

In a case where a user selects an adjustment of an exposure (adjustment of a degree of background removal), the background removal processing is carried out by (i) switching between a predetermined plurality of LUTs in accordance with a setting carried out by the user and (ii) correcting RGB values of an input image. The setting by the user is carried out via a selection input section for background removal (see FIG. 24).

(RGB Saturation Adjustment Processing)

The image quality adjustment section 22 includes a first color conversion section 61, a γ conversion section 62, and a second color conversion section 63 (see FIG. 22). FIG. 22 is a block diagram illustrating a configuration of the image quality adjustment section 22. The first color conversion section 61 converts RGB image data into a uniform color space such as an L*a*b* color system. For example, a Matrix operation can be used to make this conversion. The γ conversion section 62 carries out a γ conversion, in a uniform color space, with respect to the image data processed by the first color conversion section 61. The second color conversion section 63 converts again, into RGB image data, the image data which has been processed by the γ conversion section 62. The Matrix operation can be used to make this conversion as with the first color conversion section 61. Note that filter processing is carried out by the spatial filter section 25.

In a case where a contrast is set to “high” on a unified processing selection screen (see FIG. 24), γ which increases an entire contrast is employed in the γ adjustment made by the γ conversion section 62 (see FIG. 23). This processing is carried out for increasing a difference in density between an image region and a background so as to improve sharpness of the image. In contrast, in a case where a preview screen is not displayed, no γ adjustment is made.

[Screen Display Program]

Created preview data can be displayed by, for example, a browser used in HTML etc. For example, in the configuration illustrated in FIG. 2, preview image data generated by the image processing apparatus 3 can be loaded to a browser program and the browser is displayed on the operation panel 10.

[Computer Program and Storage Medium]

The present invention can be achieved by storing, in a computer-readable storage medium with program code (executable program, intermediate code program, or source program) to be executed by a computer, the image processing method. This makes it possible to provide a portable storage medium with a program for the image processing method.

In the present embodiment, the storage medium may be a memory for processing in a microcomputer. For example, the storage medium may be a program medium such as a ROM per se. Alternatively, the storage medium may be a program medium that can be read by inserting the storage medium into a program reading device provided as an external storage device.

In either case, the contained program code may be arranged to be accessible to a microprocessor that will execute the program code. Alternatively, the program code may be arranged to be read, downloaded to a program storage area of the microcomputer, and then executed. It is assumed that the download program is stored in the image processing apparatus 3 or the image forming apparatus 1.

The storage medium may use any of tapes, such as a magnetic tape and a cassette tape; any of disks including magnetic disks, such as a Floppy (registered trademark) disk and a hard disk, and optical disks, such as a CD-ROM, an MO, an MD, a DVD, and a CD-R; any of cards, such as an IC card (including a memory card) and an optical card; or any of semiconductor memories, such as a mask ROM, an EPROM, an EEPROM (registered trademark), and a flash ROM.

The image input apparatus 2 or the image forming apparatus 1 may be arranged to be connectable to a communication network, and the program code may be inputted via the communication network. This communication network is not particularly limited. For example, the Internet, an intranet, an extranet, a LAN, an ISDN, a VAN, a CATV communication network, a virtual private network, a telephone line network, a mobile communication network, or a satellite communication network may be used. A transmission medium forming the communication network is not particularly limited. For example, the transmission medium may be a wired configuration, such as IEEE1394, a USB, a power-line carrier, a cable TV line, a telephone line, or an ADSL line; or a wireless configuration, such as an infrared ray (e.g., IrDA or remote control), Bluetooth (registered trademark), 802.11 radio, HDR, a mobile phone network, a satellite line, or a terrestrial digital network. The present invention may be implemented in a form of a computer data signal which is embedded in a carrier wave and in which the program code is implemented by electronic transmission.

The image processing apparatus of Embodiment 1 of the present invention is an image processing apparatus for carrying out image processing to image data based on a feature of the image data, including: a detection processing section which detects, for each page of an original document with a plurality of pages, the feature of image data of each page; a detection result calculation section which (i) accumulates the feature detected by the detection processing section and (ii) calculates a frequency of the feature of the original document; and a setting section which sets a common feature, as the feature, to the image data of the plurality of pages of the original document in accordance with the frequency calculated by the detection result calculation section.

The image processing method of Embodiment 1 of the present invention is an image processing method of carrying out image processing to image data based on a feature of the image data, including the steps of: (a) detecting, for each page of an original document with a plurality of pages, the feature of image data of each page; (b) accumulating the feature detected in the step (a) and calculating a frequency of the feature of the original document; and (c) setting a common feature, as the feature, to the image data of the plurality of pages of the original document in accordance with the frequency calculated in the step (b).

With the configuration, the detection processing section (detection processing step) detects, for each page of an original document with a plurality of pages, the feature of image data of the each page. For example, the detection processing section (detection processing step) detects (i) whether the image data is color or monochrome, (ii) background, (iii) document orientation, and (iv) page size (document size). The detection result calculation section (detection result calculation step) (i) accumulates the feature detected by the detection processing section (detection processing step) and (ii) calculates a frequency of the feature of the original document. The setting section (setting step) sets a common feature, as the feature, to the image data of the plurality of pages of the original document in accordance with the frequency calculated by the detection result calculation section (detection result calculation step).

This allows the identical features to be set, as identical types of features, with respect to the plurality of pages of an original document. It is therefore possible to prevent a viewer from feeling something is wrong from one page of the plurality of pages to another in a case where image processing is carried out in accordance with a feature of image data.

Note that as to image data of an original document to be processed, image data of an original document which image data has already been stored in a memory (e.g., a USB memory or other memories) as well as image data of an original document which image data has been read by a scanner can be processed in a similar manner.

The image processing apparatus of Embodiment 2 of the present invention is an image processing apparatus for carrying out image processing to image data based on a feature of the image data, including: input means; display means; a detection processing section which detects, for each page of an original document with a plurality of pages, the feature of image data of each page; a detection result calculation section which (i) accumulates the feature detected by the detection processing section and (ii) calculates a frequency of the feature of the original document; and a control section which controls, in a case where the frequency calculated by the detection result calculation section is not less than a given threshold value, the display means to carry out displaying an input screen for permitting to set a common feature, as the feature, to the image data of the plurality of pages of the original document; and a setting section which sets the common feature, as the feature, to the image data of the plurality of pages of the original document, upon receipt of an input for permitting to set the common feature from the input means.

With the configuration, the detection processing section detects, for each page of an original document with a plurality of pages, the feature of image data of the each page. For example, the detection processing section (detection processing step) detects (i) whether the image data is color or monochrome, (ii) background, (iii) document orientation, and (iv) page size (document size).

The detection result calculation section (detection result calculation step) (i) accumulates the feature detected by the detection processing section (detection processing step) and (ii) calculates a frequency of the feature of the original document. The control section controls, in a case where the frequency calculated by the detection result calculation section is not less than a given threshold value, the display means to carry out display prompting input for permitting to set a common feature, as the feature, to the image data of the plurality of pages of the original document. The setting section sets the common feature, as the feature, with respect to the image data of the plurality of pages of the original document, upon receipt of the input for permitting to set a common feature from the input means.

This allows the identical features to be set, in accordance with the user's intention, as identical types of features, with respect to the plurality of pages of an original document. It is therefore possible to prevent a viewer from feeling something is wrong from one page of the plurality of pages to another in a case where image processing is carried out in accordance with a feature of image data.

According to the image processing apparatus of Embodiment 1 or 2, the image processing apparatus of Embodiment 3 of the present invention can be configured such that the detection processing section detects, as the feature of the image data, at least one of (i) whether the image data is color or monochrome, (ii) background, (iii) a top-to-bottom direction of the original document, and (iv) a size of each page of the original document.

With the configuration, in a case where the detection processing section detects, as the feature of the image data, whether the image data is color or monochrome, the plurality of pages of the original document are unified to color or monochrome. It is therefore possible to carry out image processing so as to prevent a viewer from feeling something is wrong as the entire original document.

In a case where the detection processing section detects, as the feature of the image data, a background, unified processing regarding background removal is carried out with respect to the plurality of pages of the original document. This makes it possible to prevent a case where the background is removed or not removed for each page in accordance with a condition of paper of the page (e.g., under color, sunburn). It is therefore possible to carry out image processing so as to prevent a viewer from feeling something is wrong as the entire original document.

In a case where the detection processing section detects, as the feature of the image data, a top-to-bottom direction, the page orientations of the plurality of pages of the original document can be aligned, so as to improve visibility of the original document. Even in a case of a page whose orientation cannot be determined (e.g., a blank page), it is possible to correct the orientation of the page. For example, in a case where a portrait document is read in a main scanning direction (in a direction along the long side of the portrait document) and in a sub scanning direction (in a direction along the short side of the portrait document), image data is created. The image data is obtained by rotating the portrait document by 90 degrees is read. In a case where the determination of the top-to-bottom direction of the original document is made with respect to such image data, it is possible to correct the image data to the original portrait document. On the other hand, since a top-to-bottom direction of a blank page document cannot be defined, the blank page document remains to be landscape. As such, in a case where a correction is carried out by rotating such a blank page document by 90 degrees as with other pages, it is possible to obtain a document in which all the pages are aligned in the identical orientation.

In a case where the detection processing section detects, as the feature of the image data, a page size, the page sizes of the plurality of pages of the original document can be unified. It is therefore possible to prevent a viewer from feeling something is wrong as the entire original document.

According to the image processing apparatus of Embodiment 1 or 3, the image processing apparatus of Embodiment 4 of the present invention can be configured to further include: input means which accepts an instruction from a user; and a control section which controls, in response to the instruction from the input means, each of the detection processing section, the detection result calculation section, and the setting section to operate.

With the configuration, the control section controls, in response to the instruction input from the input means, each of the detection processing section, the detection result calculation section, and the setting section to operate. As such, the detection processing section, the detection result calculation section, and the setting section each can operate in a situation where the user wishes, instead of always operating.

The present invention is not limited to the description of each of the embodiments above, but may be altered by a skilled person in the art within the scope of the claims. An embodiment derived from a proper combination of technical means disclosed in different embodiments is encompassed in the technical scope of the present invention.

### REFERENCE SIGNS LIST

1: Image forming apparatus
2: Image input apparatus
3: Image processing apparatus
4: Image output apparatus
5: Image display device
6: Hard disk device
7: Control section
10: Operation panel (input section)
10a: Display section
14: Document type automatic discrimination section
15: Document orientation/size detection section
22: Image quality adjustment section
23: Color correction section
24: Black generation/under color removal section
29: Detection result correction section
51: Detection result calculation section (detection result calculation section)
52: Setting section
53: Revision candidate display section
54: Revision candidate instruction section
55: Revision section

1-8. (canceled)

9. An image processing apparatus for carrying out image processing to image data based on a feature of the image data, comprising:
a detection processing section which detects, for each page of an original document with a plurality of pages, the feature of image data of each page;
a detection result calculation section which (i) accumulates the feature detected by the detection processing section and (ii) calculates a frequency of the feature of the original document; and
a setting section which sets a common feature, as the feature, to the image data of the plurality of pages of the original document in accordance with the frequency calculated by the detection result calculation section.

10. The image processing apparatus as set forth in claim 9, wherein the detection processing section detects, as the feature of the image data, at least one of (i) whether the image data is color or monochrome, (ii) background, (iii) a top-to-bottom direction of the original document, and (iv) a size of each page of the original document.

11. An image processing apparatus as set forth in claim 9, further comprising:
an input section which accepts an instruction from a user; and
a control section which controls, in response to the instruction from the input section, each of the detection processing section, the detection result calculation section, and the setting section to operate.

12. An image processing apparatus for carrying out image processing to image data based on a feature of the image data, comprising:
an input section;
a display section;
a detection processing section which detects, for each page of an original document with a plurality of pages, the feature of image data of each page;
a detection result calculation section which (i) accumulates the feature detected by the detection processing section and (ii) calculates a frequency of the feature of the original document; and
a control section which controls, in a case where the frequency calculated by the detection result calculation section is not less than a given threshold value, the display section to carry out displaying an input screen for permitting to set a common feature, as the feature, to the image data of the plurality of pages of the original document; and
a setting section which sets the common feature, as the feature, to the image data of the plurality of pages of the original document, upon receipt of an input for permitting to set the common feature from the input section.

13. An image processing method of carrying out image processing to image data based on a feature of the image data, comprising the steps of:
(a) detecting, for each page of an original document with a plurality of pages, the feature of image data of each page;
(b) accumulating the feature detected in the step (a) and calculating a frequency of the feature of the original document; and
(c) setting a common feature, as the feature, to the image data of the plurality of pages of the original document in accordance with the frequency calculated in the step (b).

14. An image forming apparatus comprising the image processing apparatus as set forth in claim 9.

15. A non-transitory computer readable storage medium in which a program for causing an image processing apparatus recited in claim 9 to operate is stored.
